(19) United States
(12) Patent Application Publication
(10) Pub. No.: US 2009/0324891 A1
(43) Pub. Date: Dec. 31, 2009

(54) RECORDABLE INFORMATION RECORDING MEDIUM

(75) Inventors: Seiji Morita, Yokohama-shi (JP); Kazuyo Umezawa, Yokohama-shi (JP); Koji Takazawa, Tokyo (JP); Naoki Morishita, Yokohama-shi (JP); Naomasa Nakamura, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/495,456

(22) Filed: Jun. 30, 2009

(30) Foreign Application Priority Data
Jun. 30, 2008 (JP) 2008-171858

(51) Int. Cl. B32B 3/30

(52) U.S. Cl. 428/167

(57) ABSTRACT

According to one embodiment, a recordable information recording medium includes an organic dye layer contains an organic dye including a cation portion having monomethinecyanine and an anion portion having an azo metal complex, and a quencher having a formazan metal complex.

### CROSS-REFERENCE TO RELATED APPLICATIONS

This application is based upon and claims the benefit of priority from Japanese Patent Application No. 2008-171858, filed Jun. 30, 2008, the entire contents of which are incorporated herein by reference.

### BACKGROUND

1. Field

One embodiment of the invention relates to a recordable information recording medium capable of recording and reproducing information by using a short-wavelength laser beam such as a blue laser beam.

2. Description of the Related Art

As is well known, the recent spread of personal computers and the like is increasing the importance of digital data storage media. For example, information recording media capable of digital recording and reproduction of, e.g., long-time video information and audio information are presently widespread. Also, information recording media for digital recording and reproduction are beginning to be used in mobile apparatuses such as cell phones.

Many information recording media of this type have disk shapes because disks have a large information recording capacity and a high random accessibility which allows rapid retrieval of desired recorded information. In addition, disks can be easily stored and carried because they are compact and light in weight, and they are also inexpensive.

Presently, so-called optical disks capable of recording and reproducing information in a non-contact state by application of a laser beam are most frequently used as disk-like information recording media. These optical disks mainly comply with the Compact Disk (CD) or Digital Versatile Disk (DVD) standards, and these two standards have compatibility.

The optical disks are classified into three types: read-only optical disks incapable of information recording such as a CD-DA (digital audio), CD-ROM (read-only memory), DVD-V (video), and DVD-ROM; recordable optical disks capable of writing information once such as a CD-R (recordable) and DVD-R; and rewritable optical disks capable of rewriting information any number of times such as a CD-RW (rewritable) and DVD-RW.

Of the optical disks capable of recording, the recordable optical disks using organic dyes in recording layers are most popular because the manufacturing cost is low. This is so because users rarely rewrite recorded information with new information when using optical disks having information recording capacities exceeding 700 MB, so it is practically only necessary to record information once.

As the volume of information increases, demands have arisen for increasing the capacity and transfer rate of optical disks. The presently commercially available optical disks are CDs, DVDs, and the like. To meet the market demand for shortening the recording time of a recordable optical disk, the transfer rate of, e.g., a CD-R has been increased to 48×, and that of, e.g., a DVD-R has been increased to 16×.

To further increase the capacity of an optical disk, an optical disk called an HD DVD has been developed. The data capacity of one side of an HD DVD-ROM or HD DVD-R is 15 GB that is three times or more the data capacity of the conventional DVD, i.e., 4.7 GB. An organic dye material is used in a recording layer of this HD DVD-R as described in, e.g., Jpn. Pat. Appln. KOKAI Publication No. 2003-308630.

Unfortunately, this HD DVD is capable of recording at only a standard velocity.

When an organic dye is used as a recording film of an optical disk, it is difficult to perform high-speed recording at 4× or more regardless of whether the disk is an HD DVD-R or BD-R.

Also, it is difficult for an optical disk having a single-layered recording film to achieve a recording power margin of ±15% or more, a reproducing light durability count of 1,000,000 or more in 4× recording and 1× playback, and a durability test (moist heat resistance test) at 80° C. and 85% for 100 hours or more.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a sectional view showing an outline of a recordable information recording medium according to the present invention; and

FIG. 2 is a view for explaining manufacturing steps of the recordable information recording medium according to the present invention.

### DETAILED DESCRIPTION

Various embodiments according to the invention will be described hereinafter with reference to the accompanying drawings. In general, according to one embodiment of the invention, a recordable information recording medium comprises a substrate having concentric or spiral grooves and lands, and a recording layer formed on the grooves and lands of the substrate, wherein the recording layer includes a reflecting layer formed on the grooves and lands, and an organic dye layer formed on the reflecting layer, a recording mark is formed in the organic dye layer by application of a short-wavelength laser beam, the light reflectance of a recording mark portion formed by application of the short-wavelength laser beam is higher than that before application of the short-wavelength laser beam, and the grooves wobble within a predetermined amplitude range. This recordable information recording medium is characterized in that the organic dye layer contains an organic dye including a cation portion made of monomethinecyanine and an anion portion made of an azo metal complex, and a quencher made of a formazan metal complex.

In the recordable information recording medium of the present invention, the recording layer includes the organic dye layer containing the organic dye having the cation portion made of monomethinecyanine and the anion portion made of an azo metal complex, and the quencher made of a formazan metal complex. This makes it possible to achieve a recording power margin of ±15% or more, a reproducing light durability count of 1,000,000 more in 4× recording and 1× playback, and a durability test (moist heat resistance test) at 80° C. and 85% for 100 hours or more.

The present invention will be explained in more detail below with reference to the accompanying drawing.

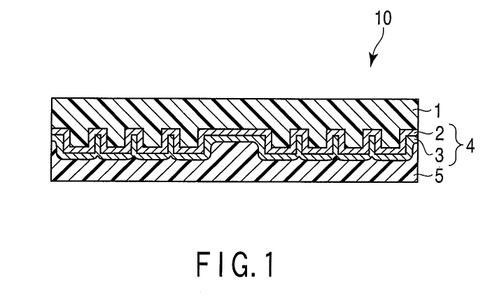

FIG. 1 is a sectional view showing an outline of an information recording medium according to the present invention.

As shown in FIG. 1, a recordable information recording medium 10 comprises a transparent substrate 1 having concentric or spiral grooves and lands and made of, e.g., polycarbonate, a recording layer 4 including a reflecting layer 2 formed on the grooves and lands of the transparent substrate 1, and an organic dye layer 3 formed on the reflecting layer 2, and a protective layer 5 formed on the recording layer 4. The organic dye layer 3 contains an organic dye including a cation portion made of monomethinecyanine and an anion portion made of an azo metal complex, and a quencher made of a formazan metal complex. A recording mark is formed in the organic dye layer 3 by application of a short-wavelength laser beam. The light reflectance of a recording mark portion formed by application of the short-wavelength laser beam is higher than that before application of the short-wavelength laser beam. The grooves wobble within a predetermined amplitude range.

As the substrate material, it is possible to use, e.g., polycarbonate, a cyclic olefin polymer, a cyclic olefin copolymer, polymethylmethacrylate, polystyrene, polypropyrene, a styrene-based polymer alloy, glass, synthetic quartz, silicon, carbon, or paper.

As the reflecting layer, it is possible to use a silver alloy such as silver bismuth.

A barrier layer, protective layer, or the like can be freely formed on the organic dye layer.

As the material of the protective layer, it is possible to use an ultraviolet-curable resin material such as an epoxy acrylate-based, urethane acrylate-based, or silicon acrylate-based material. The protective layer may also be formed by adhering, e.g., a polycarbonate film, cyclic olefin polymer film, or polymethylmethacrylate film on the ultraviolet-curable resin material.

The barrier layer is formed to prevent the problem that if the protective layer made of an ultraviolet-curable resin or the like is directly formed on the organic dye layer, the organic dye in the organic dye layer and the ultraviolet-curable resin mix with each other. As the barrier layer, it is possible to use, e.g., silicon oxide such as SiO₂, silicon nitride such as Si₃N₄, silver (Ag), a silver alloy such as AgBi, aluminum (Al), or aluminum nitride (AlN).

As the azo metal complex, a cobalt azo complex or the like can be used.

Formulas I, VI, and VIII each indicate the cation portion of a cyanine cation-cobalt azo complex anion dye usable in the present invention.

Formulas II, III, and III respectively indicate substituent groups of formulas I, VII, and VI.

Compounds C-1 to C-55 indicate practical structures of the cation portion.

Formulas A-1 to A-8 indicate azo complex anions of the anion portion.

Formulas H-1 to H-7 represent formazan complexes usable in the present invention.

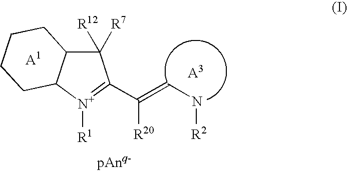

wherein a ring A¹ represents a benzene ring or naphthalene ring, a ring A³ represents a five- or six-membered ring, and this five- or six-membered ring can be condensed with or substituted by another ring. R¹ and R² each independently represent a hydrogen atom, an alkyl group having 1 to 8 carbon atoms, an aryl group having 6 to 20 carbon atoms, an arylalkyl group having 7 to 20 carbon atoms, or a substituent group represented by formula II, II′, or III below. R⁷ represents an alkyl group having 1 to 8 carbon atoms, an aryl group having 6 to 20 carbon atoms, an arylalkyl group having 7 to 20 carbon atoms, or a substituent group represented by formula II or II′ below, R¹² represents a substituent group represented by formula II or II′ below, R²⁰ represents a hydrogen atom, a hydroxyl group, a halogen atom, a nitro group, a cyano atom, an alkyl group having 1 to 8 carbon atoms, an aryl group having 6 to 20 carbon atoms, an arylalkyl group having 7 to 20 carbon atoms, or a heterocyclic group or amino group having 2 to 20 carbon atoms. A methylene group in the alkyl group having 1 to 8 carbon atoms can be substituted by —O—, —S—, —CO—, —COO—, —SO₂—, —NH—, —CONH—, —N═CH, —C≡C—, or —CH═CH—. An^{q-} represents a q-valent anion, q represents 1 or 2, and p represents a coefficient holding electric charge neutral.

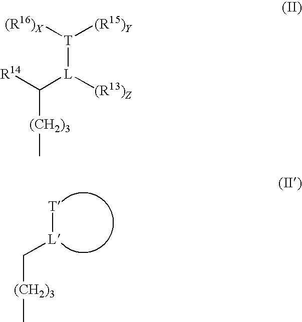

In formula II above, the bond between L and T is a double bond, conjugated double bond, or triple bond, L represents a carbon atom, T represents a carbon atom, oxygen atom, sulfur atom, or nitrogen atom, x, y, and z represent 0 or 1, s represents a number from 0 to 4, R¹³ represents a hydrogen atom, a halogen atom, or a 1- to 4-carbon alkoxy group that may be substituted by a halogen atom, R¹⁴, R¹⁵, and R¹⁶ each independently represent a hydrogen atom, a halogen atom, or a 6- to 12-carbon aryl group that may be substituted by a halogen atom, and R¹⁴ and R¹⁶ can bond to form a cyclic structure. In formula II′ above, the bond between L′ and T′ is a double bond or conjugated double bond, L′ represents a carbon atom, T′ represents a carbon atom, oxygen atom, or nitrogen atom, s′ represents a number from 0 to 4, a ring containing L′ and T′ represents a six-membered ring that may contain a hetero atom, a naphthalene ring, a quinoline ring, an isoquinoline ring, an anthracene ring, or an anthraquinone ring, and the ring containing L′ and T′ can be substituted by a halogen atom, nitro group, cyano group, alkyl group, or alkoxy group.

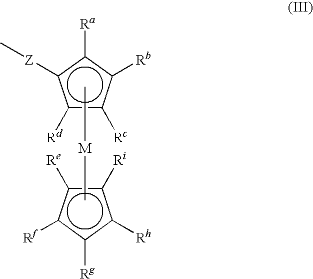

wherein R^{a} to Rⁱ each independently represent a hydrogen atom, a hydroxyl group, or an alkyl group having 1 to 4 carbon atoms, a methylene group in this alkyl group may be substituted by —O— or —CO—, Z represents a 1- to 8-carbon alkylene group that may have a direct bond or substituent group, a methylene group in this alkylene group may be substituted by —O—, —S—, —CO—, —COO—,

—OCO—, —SO₂—, —NH—, —CONH—, —NHCO—, —N═CH, or —CH═CH—, and M represents a metal atom.

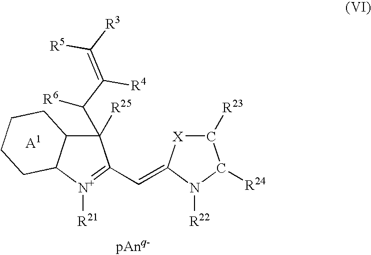

wherein a ring A¹ represents a benzene ring or naphthalene ring, x represents a carbon atom, oxygen atom, sulfur atom, selenium atom, —R⁸R⁹—, —NH—, or —NR′—, R, R²¹, and R²² each independently represent a hydrogen atom, an alkyl group having 1 to 8 carbon atoms, an aryl group having 6 to 20 carbon atoms, an arylalkyl group having 7 to 20 carbon atoms, or a substituent group represented by formula VII below. R³, R⁴, R⁵, and R⁶ each independently represent a hydrogen atom, a halogen atom, an alkyl group having 1 to 8 carbon atoms, or an aryl group having 6 to 12 carbon atoms, R³ and R⁴ may combine to form a ring, R²⁵ and R⁸ and R⁹ as groups in X each independently represent an alkyl group having 1 to 8 carbon atoms, an aryl group having 6 to 20 carbon atoms, an arylalkyl group having 7 to 20 carbon atoms, or a substituent group represented by formula VII below, and R⁸ and R⁹ can combine to form a ring. R²⁵ and R³⁴ each independently have a hydrogen atom, a hydroxyl group, an alkyl group having 1 to 8 carbon atoms, an alkoxy group having 1 to 8 carbon atoms, an aryl group having 6 to 30 carbon atoms, a halogen atom, a nitro group, a cyano group, or a substituent group represented by formula III above, and R²³ and R²⁴ can combine to form a cyclic structure. A methylene group in the alkyl group having 1 to 8 carbon atoms can be substituted by —O— or —CH═CH—. An^{q-} represents a q-valent anion, q represents 1 or 2, and p represents a coefficient holding electric charge neutral.

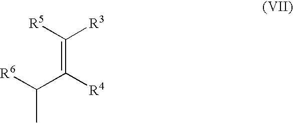

wherein R³, R⁴, R⁵, and R⁶ are the same as those in formula VI above.

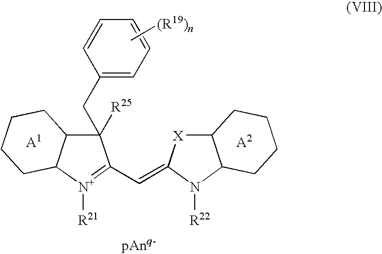

wherein a ring A¹ represents a benzene ring or naphthalene ring, R¹⁹ represents a hydrogen atom, a hydroxyl group, an alkyl group having 1 to 8 carbon atoms, an alkoxy group having 1 to 8 carbon atoms, an aryl group having 6 to 30 carbon atoms, a heterocyclic group having 2 to 20 carbon atoms, a halogen atom, a nitro group, or a cyano group, n is a number from 1 to 5, and A¹, R²¹, R²², R²⁵, X, An^{q-}, p, and q are the same as those in formula VI above.

In formula VIII above, examples of the heterocyclic group having 2 to 20 carbon atoms represented by R¹⁹ are pyridyl, pyrimidyl, pyridazyl, piperazyl, piperizyl, pyranyl, pyrazoyl, triazyl, pyrrolidyl, quinolyl, isoquinolyl, imidazolyl, benzoimidazolyl, triazolyl, furyl, furanyl, benzofuranyl, thienyl, thiophenyl, benzothiophenyl, thiadiazolyl, thiazolyl, benzothiazolyl, oxazolyl, benzoxazolyl, isothiazolyl, indolyl, julolidyl, morpholinyl, thiomorpholinyl, 2-pyrrolidinone-1-yl, 2-piperidone-1-yl, 2,4-dioxyimidazoceridine-3-yl, and 2,4-dioxyoxazolidine-3-yl.

Examples of the alkyl group having 1 to 8 carbon atoms and the halogen atom represented by R¹⁹ are the groups exemplified in the explanation of formula I above. Examples of the alkoxy group having 1 to 8 carbon atoms and the aryl group having 6 to 30 carbon atoms represented by R¹⁹ are the groups exemplified in the explanation of formula VI above.

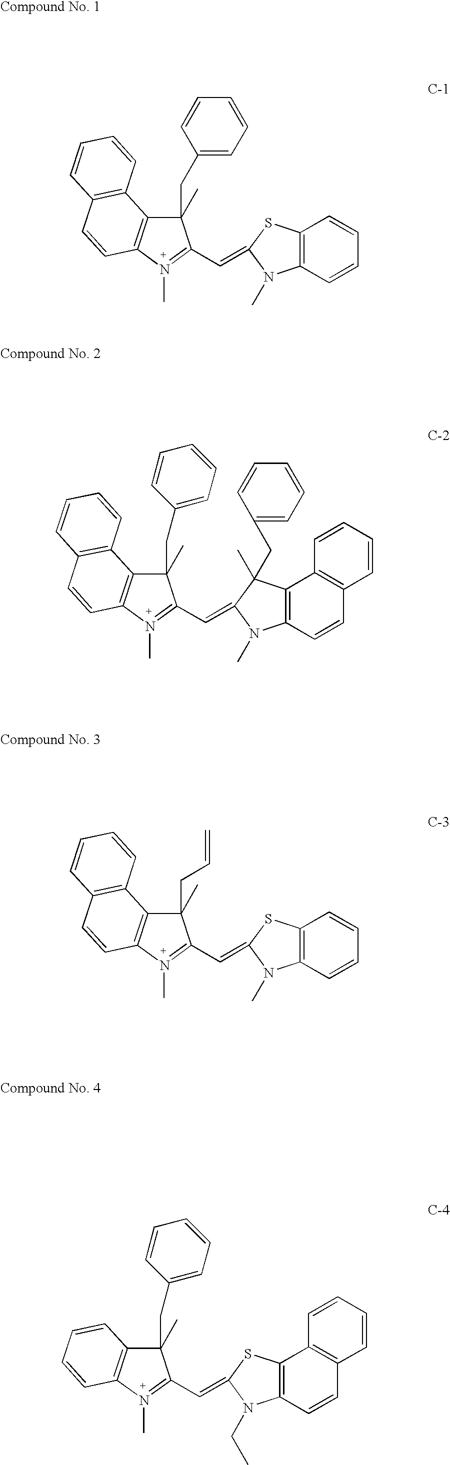

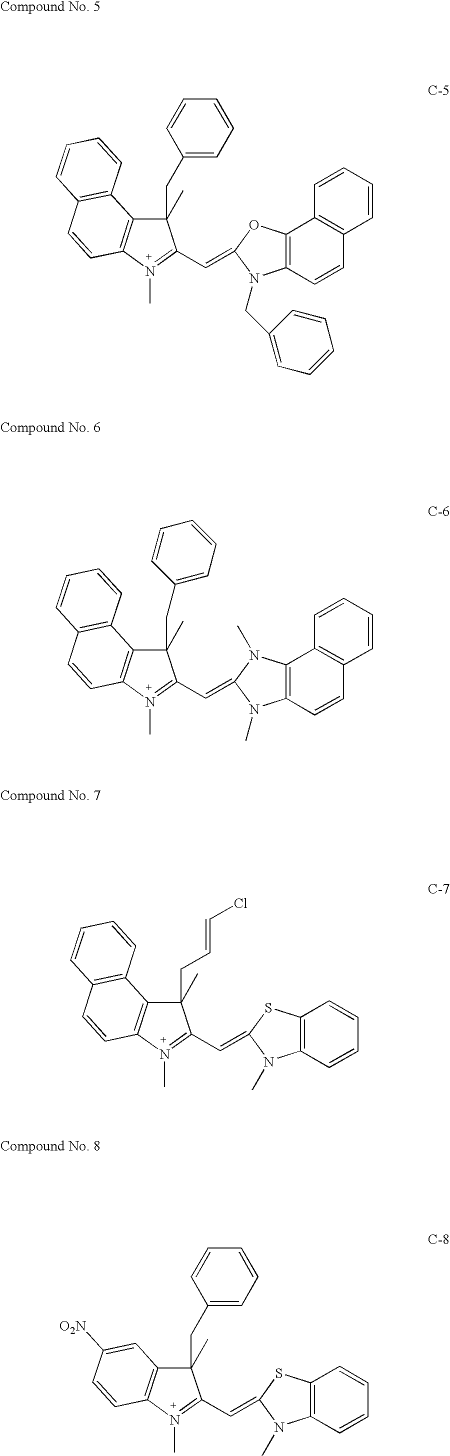

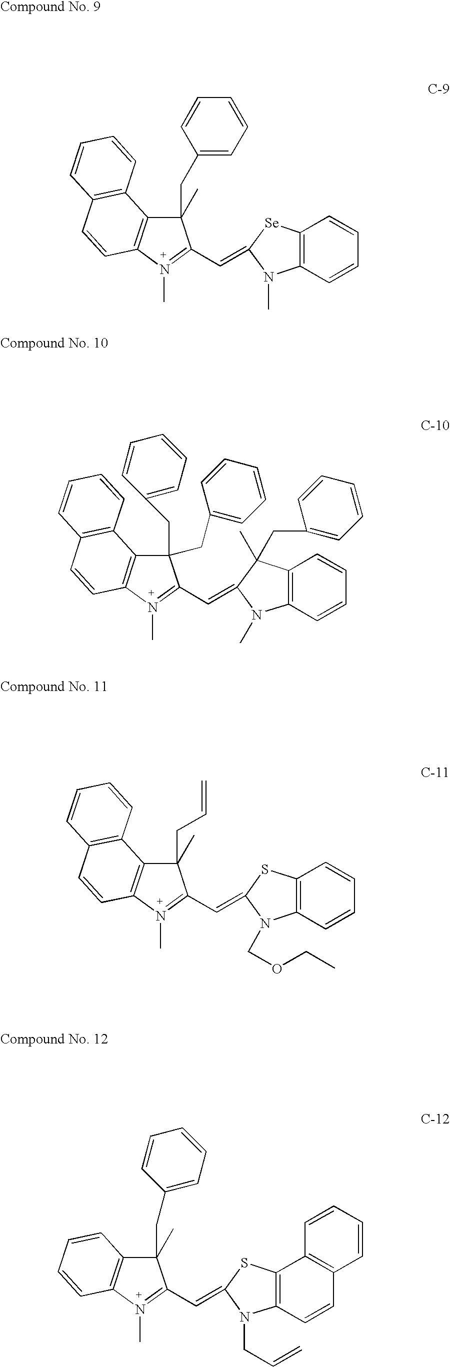

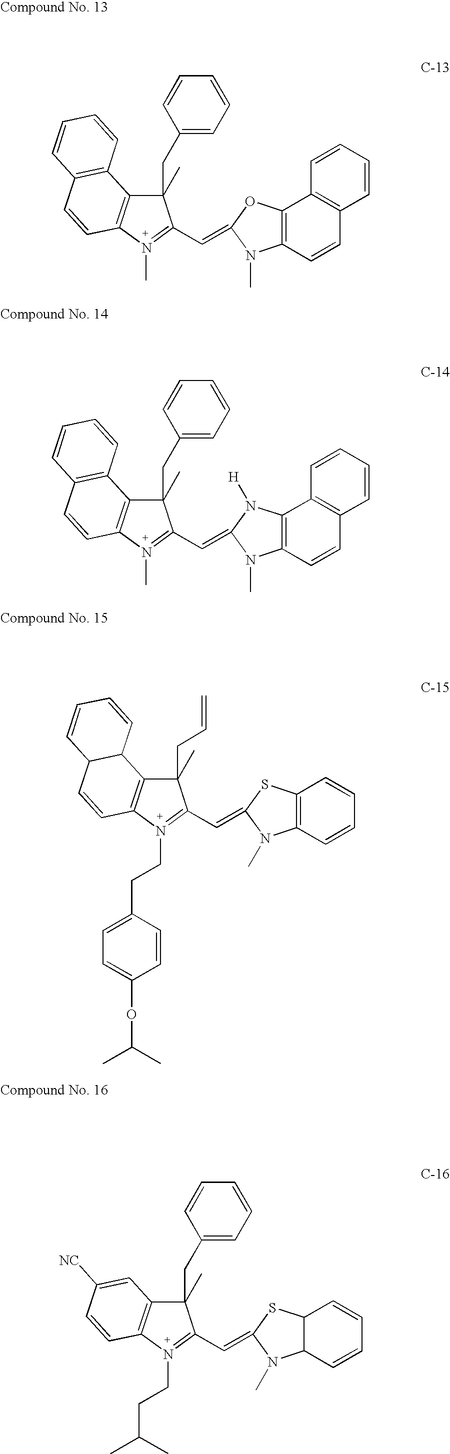

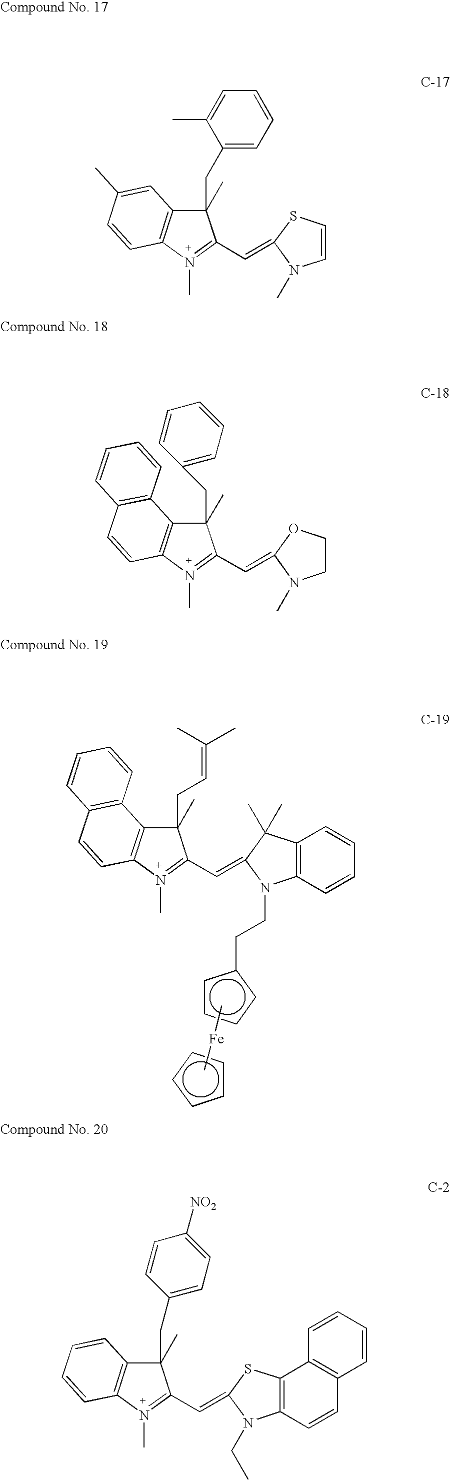

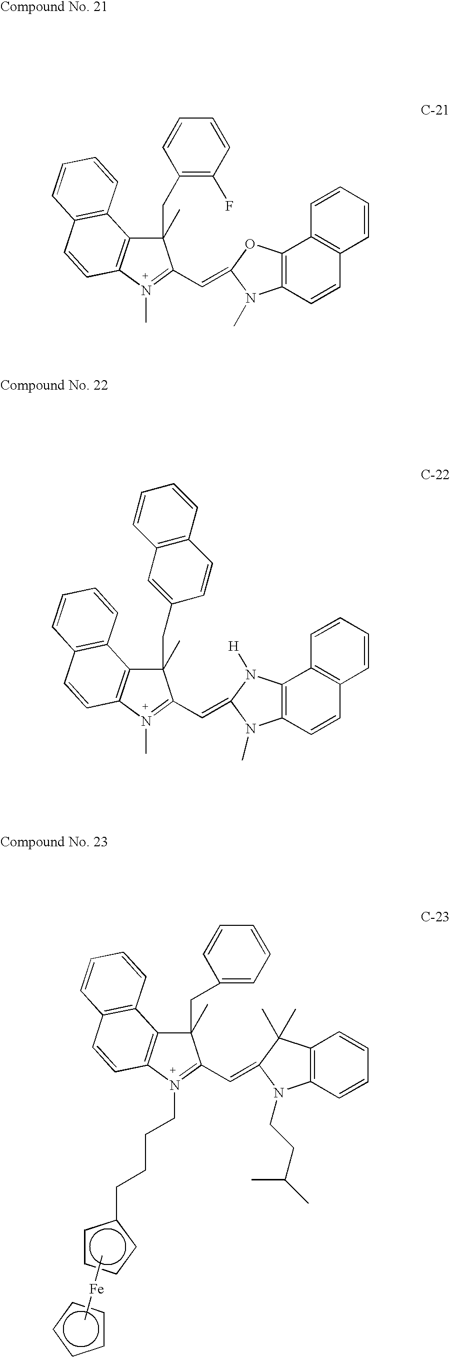

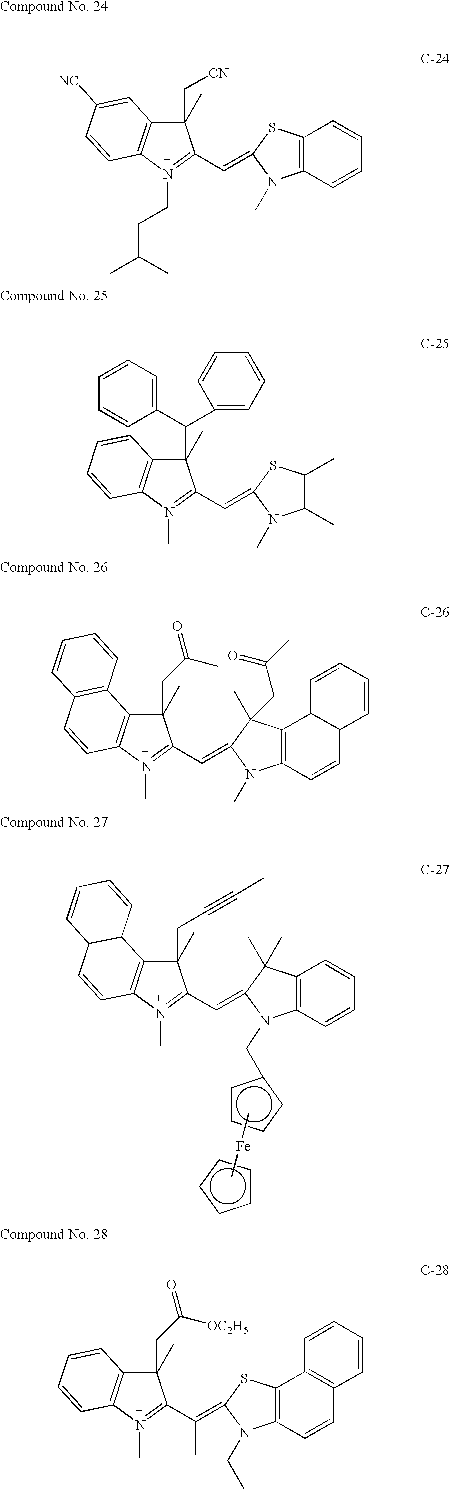

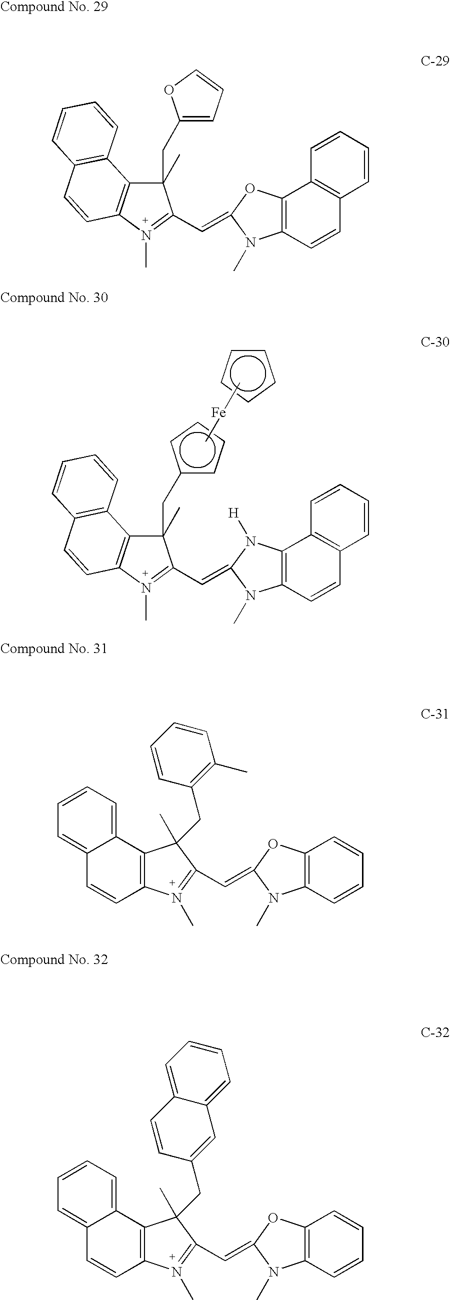

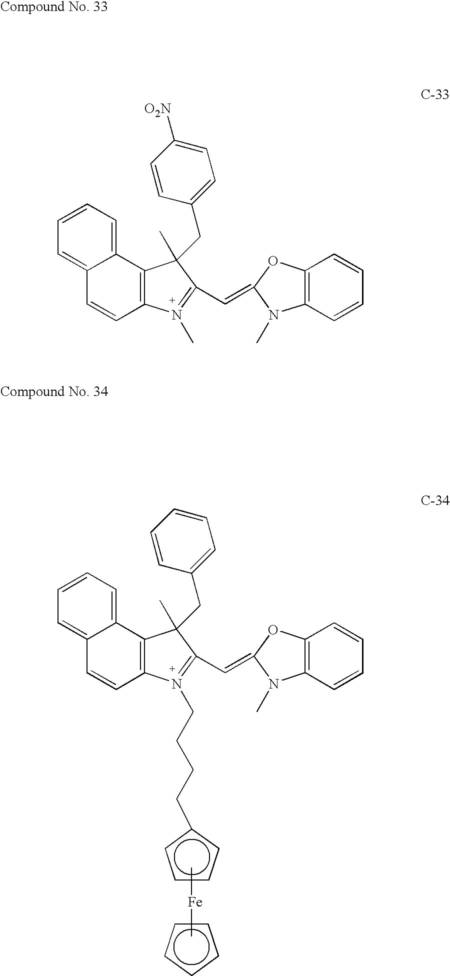

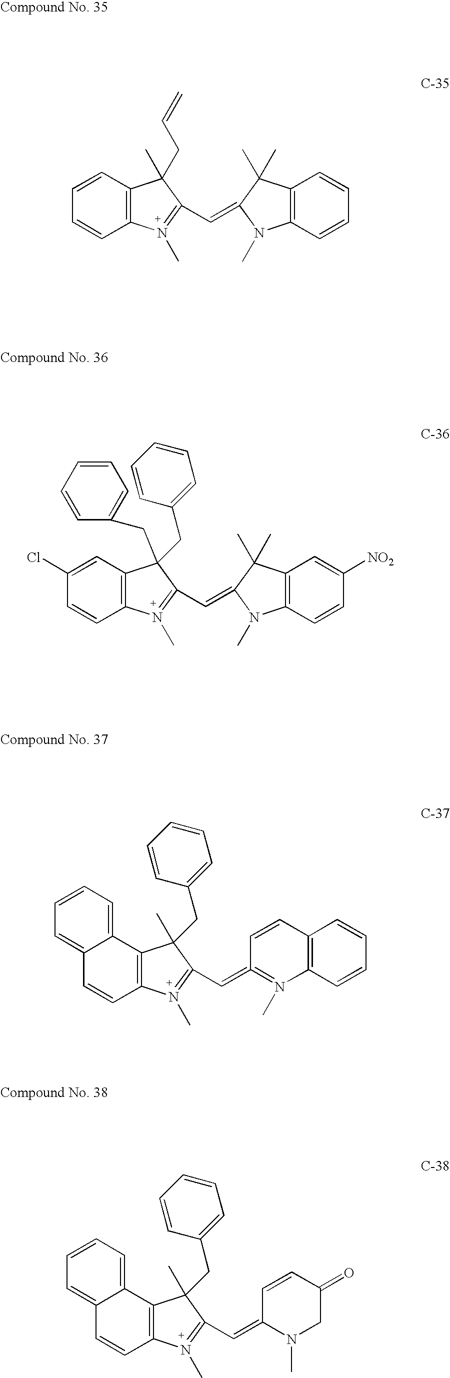

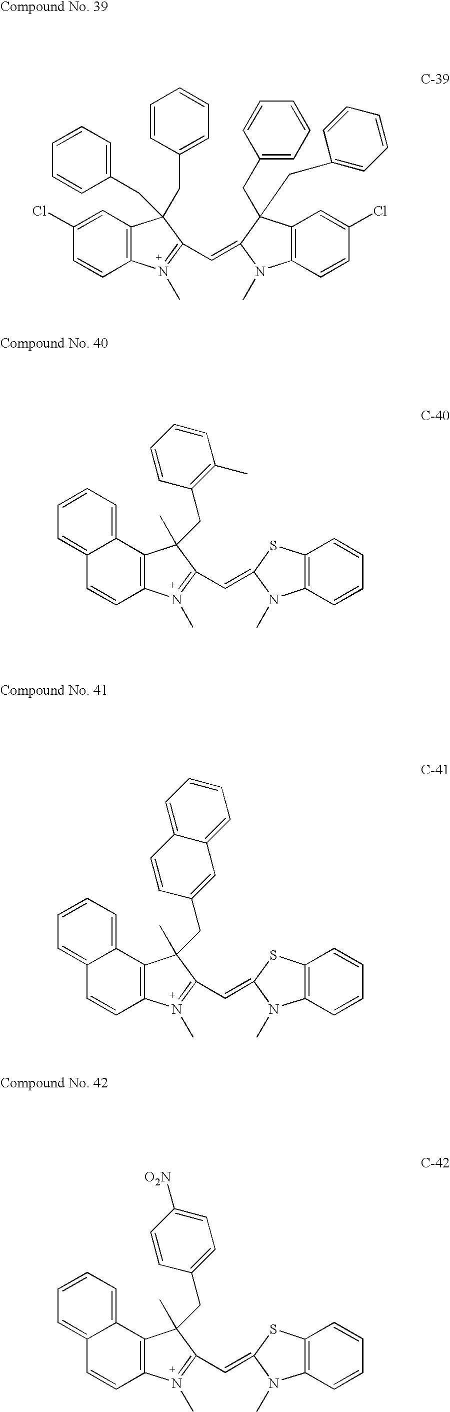

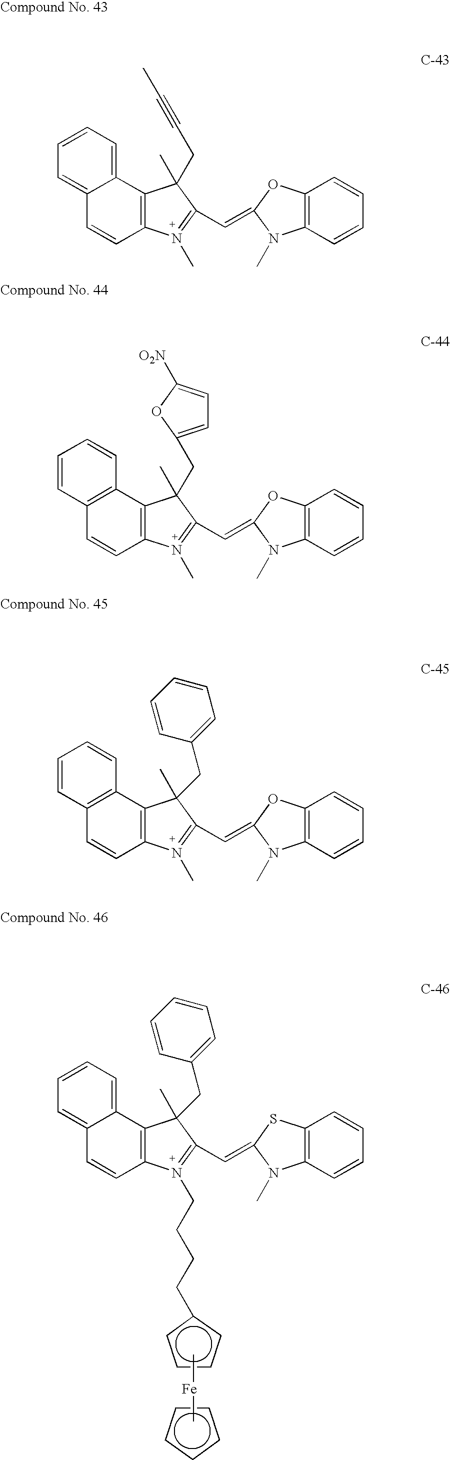

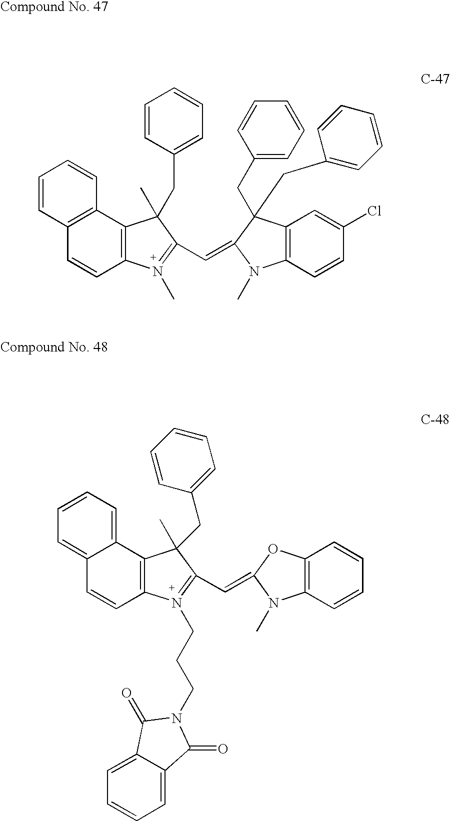

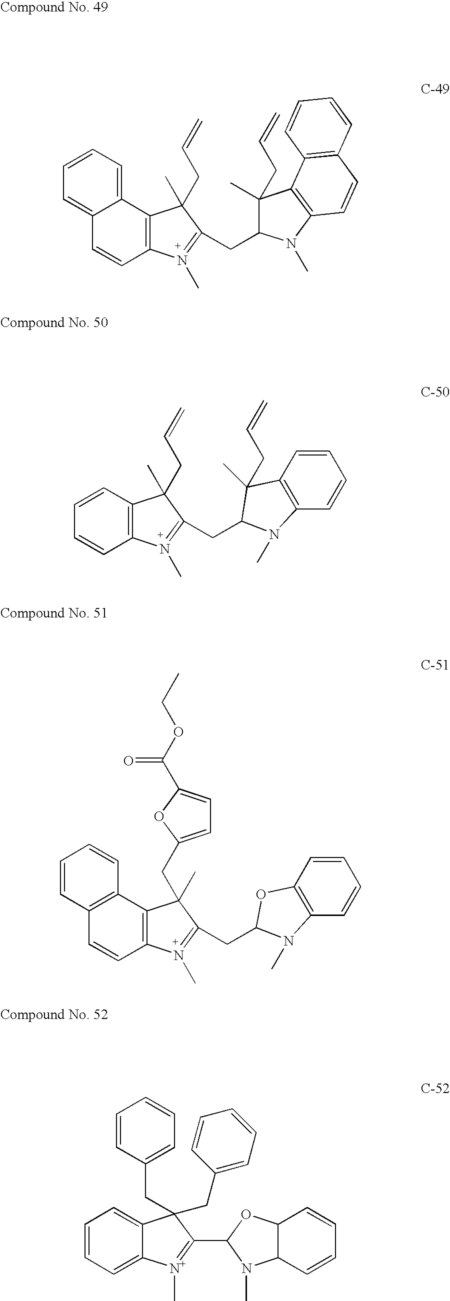

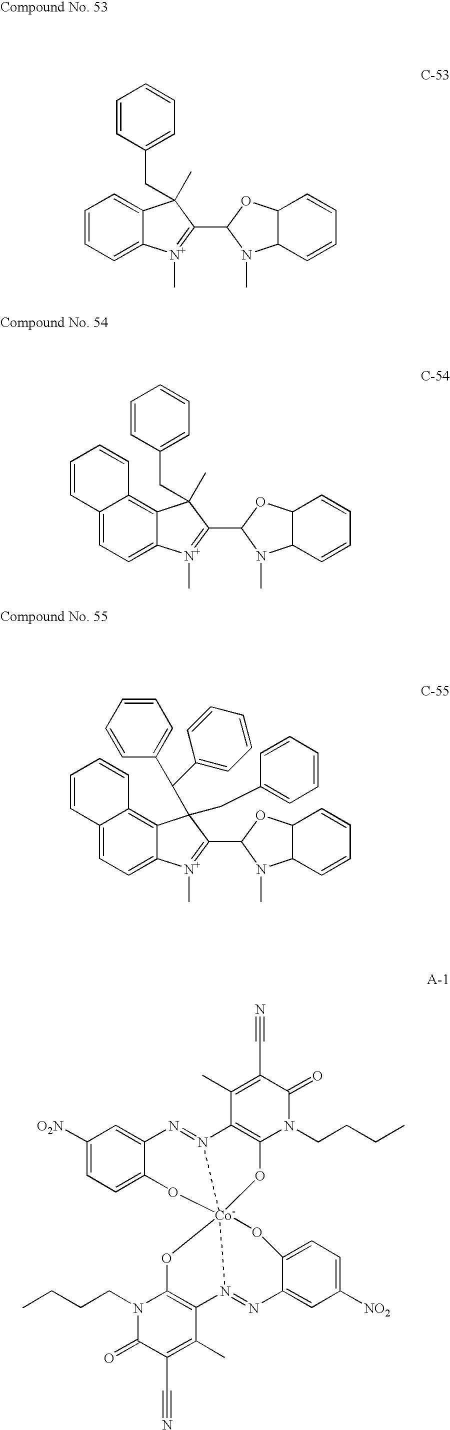

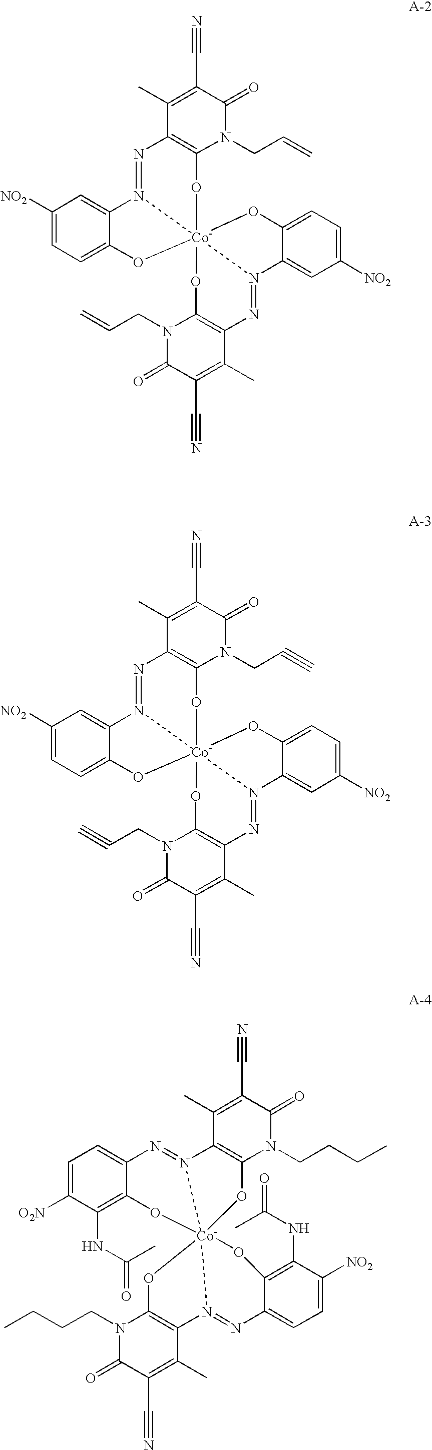

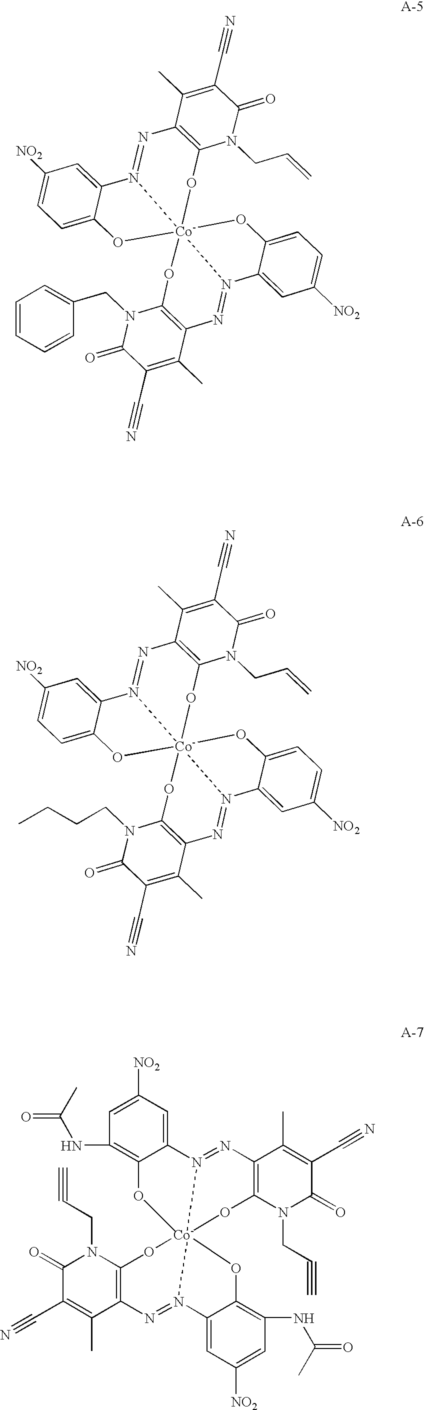

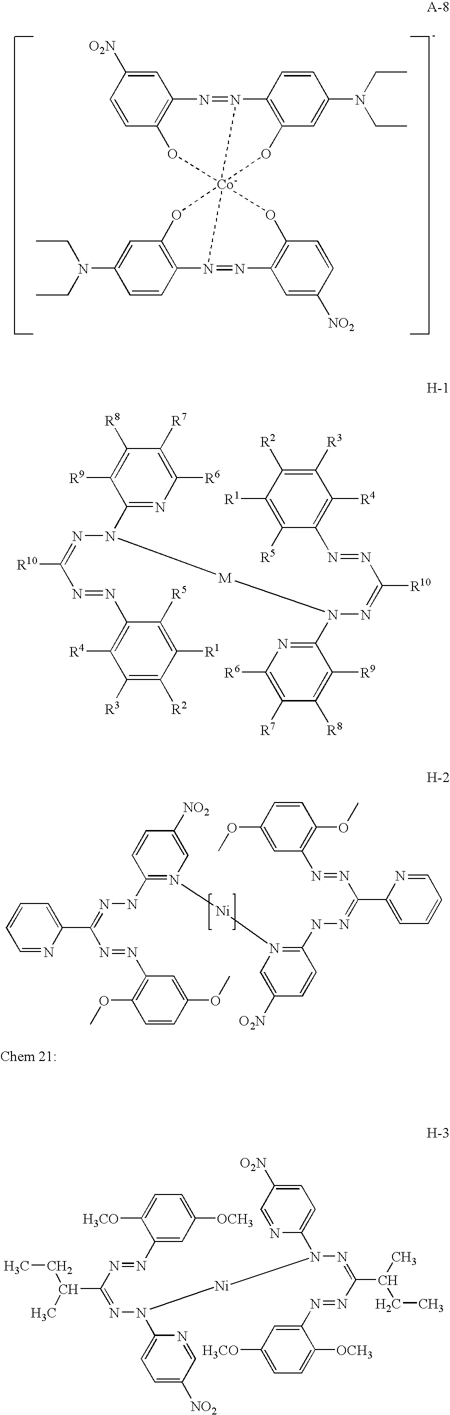

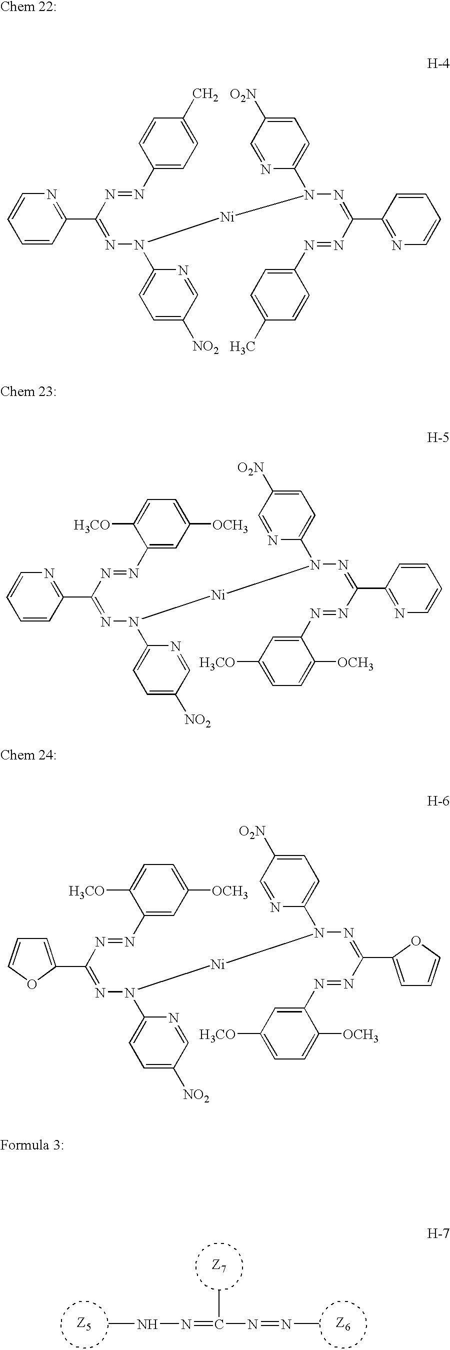

The formazan metal complex according to the present invention means the overall complex containing a metal atom as a central atom and one or more formazan complexes which are bonded to the metal atom as ligands. In other words, a formazan complex represented by H-7 (formula 3) is defined as a lingand.

With respect to H-1, R¹, R², R³, R⁴, R⁵, R⁶, R⁷, R⁸ and R⁹ are independently an optionally substituted aliphatic hydrocarbon having from 1 to 5 carbon atoms, an optionally substituted ether group having from 1 to 7 carbon atoms, an optionally substituted amino group having from 1 to 8 carbon atoms; a halogen group; a nitro group, or a cyano group. The number of carbon atoms in these groups refers to the number of carbon atoms in the parent group and does not include any carbon atoms in any substituents.

R¹, R², R³, R⁴, R⁵, R⁶, R⁷, R⁸ and R⁹ are optionally substituted, meaning that they may be unsubstituted or may optionally have one or more substituents in place of one or more hydrogen atoms. In some embodiments, these substituents may be selected from an aliphatic hydrocarbon, such as an aliphatic hydrocarbon having from 1 to 5 carbon atoms; an ether group, such as an ether group having from 1 to 7 carbon atoms; a halogen group; an optionally fluorinated ester group, such as an optionally fluorinated ester group having from 1 to 7 carbon atoms; and an aromatic hydrocarbon group, such as an aromatic hydrocarbon group having from 6 to 12 carbon atoms.

In H-7 (formula 3), Z5 represents a pyridine ring, and the pyridine ring may have one or more substituents. As the substituents, namely, R⁶, R⁷, R⁸ and R9 of H-1, there are a methyl group, an ethyl group, a propyl group, an isopropyl group, a butyl group, an isobutyl group, an aliphatic hydrocarbon group such as a sec-butyl group, a tert-butyl group, a pentyl group, an isopentyl group, a neopentyl group and a tert-pentyl group, an ether group such as a methoxy group, an ethoxy group, a propoxy group, an isopropoxy group, a butoxy group, an isobutoxy group, a sec-butoxy group, a tert-butoxy group, a penthyloxy group, a phenoxy group and a benzyloxy group, an amino group such as a methylamino group, a dimethylamino group, an ethylamino group, a diethylamino group, a propylamino group, a dipropylamino group, an isopropylamino group, a diisobutylamino group, a sec-butylamino group, a tert-butylamino group, a pentylamino group, an anilino group, an o-toluidino group, an m-toluidino group, a p-toluidine group, a xylidino group, a piperidino group, a piperazino group and a morpholino group, and a halogen group such as a fluoro group, a chloro group, a bromo group and an iodine group, a nitro group, and a cyano group.

One or more hydrogen atoms in the substituents can be replaced by a methyl group, an ethyl group, a propyl group, an isopropyl group, a butyl group, an isobutyl group, an aliphatic hydrocarbon group such as a sec-butyl group, a tert-butyl group, a pentyl group, an isopentyl group, a neopentyl group and a tert-pentyl group, an ether group such as a methoxy group, an ethoxy group, a propoxy group, an isopropoxy group, a butoxy group, an isobutoxy group, a sec-butoxy group, a tert-butoxy group, a penthyloxy group, a phenoxy group and a benzyloxy group, a halogen group such as a fluoro group, a chloro group, a bromo group and an iodine group, an ester group such as a methoxycarbonyl group, a trifluoromethoxycarbonyl group, an ethoxycarbonyl group, a propoxycarbonyl group, an acetoxy group, a trifluoroacetoxy group and a benzoyloxy group, and an aromatic hydrocarbon group such as a phenyl group, an o-tolyl group, an m-tolyl group, a p-tolyl group, a xylyl group, a mesityl group, an o-cumenyl group, an m-cumenyl group, a p-cumenyl group and a biphenylyl group.

In H-7 (formula 3), Z6 represents an aromatic ring or a heterocyclic ring. As the aromatic ring in Z6, there are a benzene ring, a naphthalene ring, an anthracene ring, and the like. As the heterocyclic ring in Z6, there are an imidazole ring, a benzoimidazole ring, a quinoline ring, an isoquinoline ring, an oxazole ring, a benzoxazole ring, a thiazole ring, a benzothiazole ring, a piperazine ring, a pyridine ring, a pyridazine ring, a pyrimidine ring, and the like. These aromatic and heterocyclic rings each may have one or more substituents as in Z5.

For example, R¹, R², R³, R⁴ and R⁵ may independently be a methyl group, an ethyl group, a propyl group, an isopropyl group, a butyl group, an isobutyl group, an aliphatic hydrocarbon group such as a sec-butyl group, a tert-butyl group, a pentyl group, an isopentyl group, a neopentyl group and a tert-pentyl group, an ether group such as a methoxy group, an ethoxy group, a propoxy group, an isopropoxy group, a butoxy group, an isobutoxy group, a sec-butoxy group, a tert-butoxy group, a penthyloxy group, a phenoxy group and a benzyloxy group, an amino group such as a methylamino group, a dimethylamino group, an ethylamino group, a diethylamino group, a propylamino group, a dipropylamino group, an isopropylamino group, a diisobutylamino group, a sec-butylamino group, a tert-butylamino group, a pentylamino group, an anilino group, an o-toluidino group, an m-toluidino group, a p-toluidine group, a xylidino group, a piperidino group, a piperazino group and a morpholino group, and a halogen group such as a fluoro group, a chloro group, a bromo group and an iodine group, a nitro group, and a cyano group.

One or more hydrogen atoms in the substituents may be replaced by a methyl group, an ethyl group, a propyl group, an isopropyl group, a butyl group, an isobutyl group, an aliphatic hydrocarbon group such as a sec-butyl group, a tert-butyl group, a pentyl group, an isopentyl group, a neopentyl group and a tert-pentyl group, an ether group such as a methoxy group, an ethoxy group, a propoxy group, an isopropoxy group, a butoxy group, an isobutoxy group, a sec-butoxy group, a tert-butoxy group, a penthyloxy group, a phenoxy group and a benzyloxy group, a halogen group such as a fluoro group, a chloro group, a bromo group and an iodine group, an ester group such as a methoxycarbonyl group, a trifluoromethoxycarbonyl group, an ethoxycarbonyl group, a propoxycarbonyl group, an acetoxy group, a trifluoroacetoxy group and a benzoyloxy group, and an aromatic hydrocarbon group such as a phenyl group, an o-tolyl group, an m-tolyl group, a p-tolyl group, a xylyl group, a mesityl group, an o-cumenyl group, an m-cumenyl group, a p-cumenyl group and a biphenylyl group.

In H-1 (formula 3), Z7, namely, each R¹⁰ is independently an optionally substituted pyridine ring, an optionally substituted furan ring, or an optionally substituted aliphatic hydrocarbon group having from 1 to 5 carbon atoms. The number of carbon atoms in these groups refers to the number of carbon atoms in the parent group and does not include any carbon atoms in any substituents.

Each R¹⁰ is optionally substituted, meaning that it may be unsubstituted or may optionally have one or more substituents in place of one or more hydrogen atoms.

In some embodiments, any substituent of R¹⁰ may be independently selected from: an optionally substituted aliphatic hydrocarbon having from 1 to 5 carbon atoms, an optionally substituted ether group having from 1 to 7 carbon atoms, an optionally substituted amino group having from 1 to 8 carbon atoms, a halogen group, a nitro group, and a cyano group.

For those substituents of R¹⁰ which are also optionally substituted, in some embodiments, these secondary substituents (i.e. substituents of substituents) may be independently selected from: an aliphatic hydrocarbon having from 1 to 5 carbon atoms, an ether group having from 1 to 7 carbon atoms, a halogen group, an optionally fluorinated ester group having from 1 to 7 carbon atoms, and an aromatic hydrocarbon group having from 6 to 12 carbon atoms.

For example, in some embodiments, R¹⁰ represents a pyridine ring, a furan ring or an aliphatic hydrocarbon group. These pyridine and furan rings each may have one or more substituents as in Z5. As the substituents, there are a methyl group, an ethyl group, a propyl group, an isopropyl group, a butyl group, an isobutyl group, an aliphatic hydrocarbon group such as a sec-butyl group, a tert-butyl group, a pentyl group, an isopentyl group, a neopentyl group and a tert-pentyl group, an ether group such as a methoxy group, an ethoxy group, a propoxy group, an isopropoxy group, a butoxy group, an isobutoxy group, a sec-butoxy group, a tert-butoxy group, a penthyloxy group, a phenoxy group and a benzyloxy group, an amino group such as a methylamino group, a dimethylamino group, an ethylamino group, a diethylamino group, a propylamino group, a dipropylamino group, an isopropylamino group, a diisobutylamino group, a sec-butylamino group, a tert-butylamino group, a pentylamino group, an anilino group, an o-toluidino group, an m-toluidino group, a p-toluidine group, a xylidino group, a piperidino group, a piperazino group and a morpholino group, and a halogen group such as a fluoro group, a chloro group, a bromo group and an iodine group, a nitro group, and a cyano group.

One or more hydrogen atoms in the substituents can be replaced by a methyl group, an ethyl group, a propyl group, an isopropyl group, a butyl group, an isobutyl group, an aliphatic hydrocarbon group such as a sec-butyl group, a tert-butyl group, a pentyl group, an isopentyl group, a neopentyl group and a tert-pentyl group, an ether group such as a methoxy group, an ethoxy group, a propoxy group, an isopropoxy group, a butoxy group, an isobutoxy group, a sec-butoxy group, a tert-butoxy group, a penthyloxy group, a phenoxy group and a benzyloxy group, a halogen group such as a fluoro group, a chloro group, a bromo group and an iodine group, an ester group such as a methoxycarbonyl group, a trifluoromethoxycarbonyl group, an ethoxycarbonyl group, a propoxycarbonyl group, an acetoxy group, a trifluoroacetoxy group and a benzoyloxy group, and an aromatic hydrocarbon group such as a phenyl group, an o-tolyl group, an m-tolyl group, a p-tolyl group, a xylyl group, a mesityl group, an o-cumenyl group, an m-cumenyl group, a p-cumenyl group and a biphenylyl group.

The aliphatic hydrocarbon group in Z7, namely, R10 of H-1, is usually selected from the groups whose carbon number is one to five, such as a methyl group, an ethyl group, a propyl group, an isopropyl group, a butyl group, an isobutyl group, a sec-butyl group, a tert-butyl group, a pentyl group, an isopentyl group, a neopentyl group and a tert-pentyl group, and one or more hydrogen atoms in the aliphatic hydrocarbon group can be replaced by a halogen group such as a fluoro group.

The hydrogen atoms of an imino group in the formazan complex are generally movable. Therefore, of the hormazan complexes represented by H-7 (formula 3), Z5 and Z6 whose structures are different and asymmetrical to each other have two tautomers in theory. In the present invention, the hormazan complexes include all the tautomers, except where specifically noted.

With respect to H-1, M may be scandium, yttrium, titanium, zirconium, hafnium, vanadium, niobium, tantalum, chrome, molybdenum, tungsten, manganese, technetium, rhenium, iron, cobalt, nickel, rubidium, rhodium, palladium, osmium, iridium, platinum, copper, gold, zinc, cadmium, and mercury, or oxide of these elements, and halide such as fluoride of these elements, chloride thereof, bromide thereof and iodide thereof. In terms of costs and availability, nickel, zinc, cobalt, iron, copper, palladium, an oxide of these elements, and halide are more suitable as the central metal.

The present invention will be explained in more detail below by way of its examples.

### EXAMPLES

First, a single-layered BD-R disk was manufactured as follows.

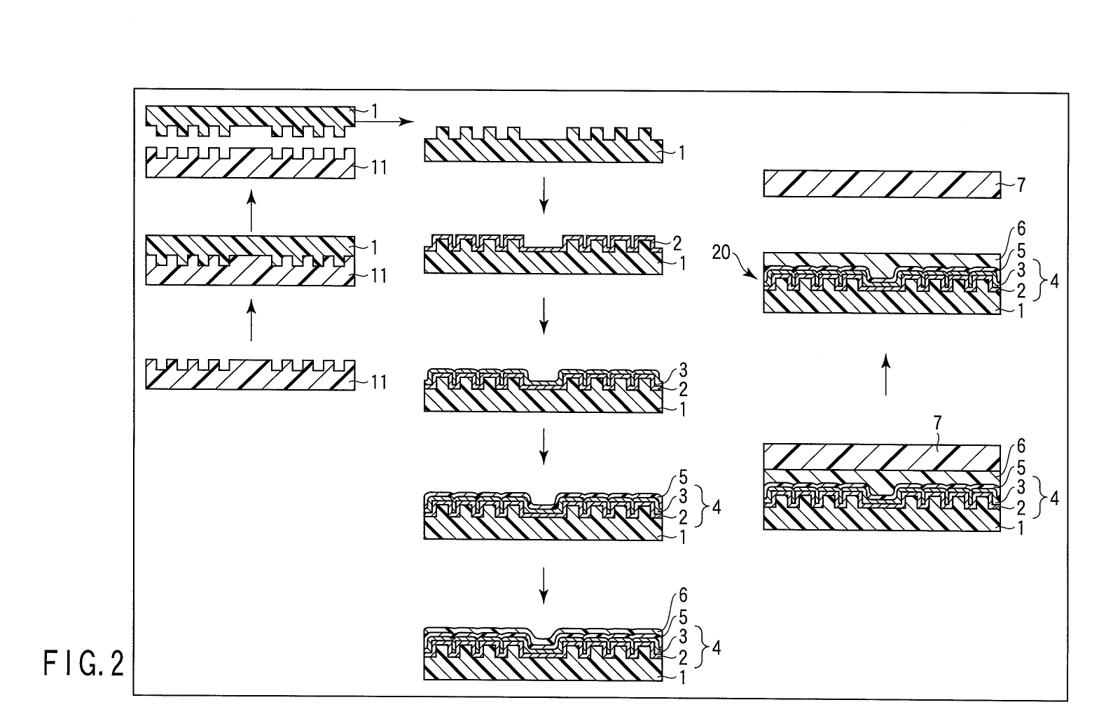

FIG. 2 is a schematic view showing steps in manufacturing the single-layered BD-R disk of the present invention.

An Ni stamper 11 for a BD-R was manufactured by an electron beam mastering process, and a 1.1-mm-thick polycarbonate substrate 1 was duplicated from the stamper 11 by injection molding. A format complying with the Blu-ray Disc Recordable Format Version 1.2 (BD-R LTH Type standards) was used. The track pitch was 0.32 μm, the groove width of the substrate 1 was 0.2 μm, and the groove depth of the substrate 1 was 50 nm.

Then, a reflecting layer 2 (AgBi [Bi was 1 atm. %] alloy layer) was formed by sputtering on the injection-molded disk substrate 1 by using the Stella sputtering apparatus manufactured by Shibaura Mechatronics. The thickness of the AgBi film was 100 nm. Subsequently, an organic dye layer 3 was formed by spin coating of an organic dye solution (prepared by dissolving 1.4 g of an organic dye powder in 100 ml of TFP: tetrafluoropropanol) by using a spin coater manufactured by Origin Electric. The organic dye layer 3 and reflecting layer 2 formed a recording layer 4. After that, the disk substrate was baked in a clean oven at 80° C. for 30 minutes. Then, a barrier layer 5 (SiO₂ layer) was formed by sputtering by using the RF Sputtering Model sputtering apparatus manufactured by Shibaura Mechatronics. The thickness of the SiO₂ film 5 was 50 nm.

Subsequently, a spin bonding apparatus manufactured by Origin Electric was used to form an acrylate-based, ultraviolet-curable resin layer 6′ by applying an acrylate-based, ultraviolet-curable resin material (the MTUH614 thick film type manufactured by Addison Clear Wave LLC) by spin coating, and bond a dummy polycarbonate substrate 7 (0.6 mm thick, no pattern) on the acrylate-based, ultraviolet-curable resin layer 6′. The thickness of the ultraviolet-curable resin layer 6′ was 100 μm. After that, the ultraviolet-curable resin was cured by UV irradiation, and the dummy polycarbonate substrate 7 was removed by a substrate removing apparatus manufactured by Origin Electric, thereby obtaining a cover layer 6 made of the cured ultraviolet-curable resin layer. In this way, a single-layered BD-R disk 20 was manufactured.

A plurality of types of organic dye solutions were prepared by dissolving powders of organic dyes having the structures as described previously in TFP, thereby manufacturing BD-R disks having different organic dye recording films. When mixing the quencher, a BD-R disk was manufactured by dissolving both the organic dye powder and quencher powder in TFP such that the mixing ratio of the quencher powder was 5 wt % with respect to the total weight of the organic dye powder and quencher powder.

The recording/playback characteristics of the manufactured BD-R disks were evaluated by using the ODU1000 for BD-R evaluation manufactured by Pulstec. The 1× linear velocity was 4.92 m/s.

The evaluation items were the jitter (after the passage through a limit equalizer), reflectance, signal modulation degree, and playback durability. A recording power margin by which the jitter was 8% or less was also evaluated by changing the recording power. A recording power margin of ±15% or more is necessary in practical recording and playback using a drive apparatus. The playback durability was evaluated as jitter deterioration when the disk was continuously played back at 1× with a playback power of 0.3 mW. A jitter of 8% or less is necessary in practical playback using a drive apparatus when the number of times of playback is 1,000,000 or more.

Tables 1 to 8 below show the evaluation results when H-2 was added as the quencher and compounds shown in these tables were added as the cation and anion.

Tables 9 to 16 below show the evaluation results when no quencher was added as comparative examples.

Also, Table 17 below shows the measurement results of the recording power margin and reproducing light durability count when the quencher addition amount was 2, 3, 5, 10, and 11%.

The recording power margin and reproducing light durability were good within the range of 3 to 10%. The range of 3 to 10% was best even for dyes other than the two types of dyes.

TABLE 1

| | | | | Power | Playback |
|---|---|---|---|---|---|
| Sample | | | | margin | durability |
| No. | Cation | Anion | Quencher | (%) | (×10,000 times) |
| 1 | C-1 | A-8 | Added | 20 | 120 |
| 2 | C-2 | A-8 | Added | 19 | 110 |
| 3 | C-3 | A-8 | Added | 20 | 130 |
| 4 | C-4 | A-8 | Added | 18 | 120 |
| 5 | C-5 | A-8 | Added | 18 | 125 |
| 6 | C-6 | A-8 | Added | 19 | 125 |
| 7 | C-7 | A-8 | Added | 19 | 125 |
| 8 | C-8 | A-8 | Added | 19 | 125 |
| 9 | C-9 | A-8 | Added | 19 | 125 |
| 10 | C-10 | A-8 | Added | 19 | 125 |
| 11 | C-11 | A-8 | Added | 19 | 125 |
| 12 | C-12 | A-8 | Added | 20 | 125 |
| 13 | C-13 | A-8 | Added | 20 | 125 |
| 14 | C-14 | A-8 | Added | 18 | 125 |
| 15 | C-15 | A-8 | Added | 18 | 125 |
| 16 | C-16 | A-8 | Added | 18 | 125 |
| 17 | C-17 | A-8 | Added | 17 | 125 |
| 18 | C-18 | A-8 | Added | 16 | 125 |
| 19 | C-19 | A-8 | Added | 17 | 125 |
| 20 | C-20 | A-8 | Added | 17 | 125 |
| 21 | C-21 | A-8 | Added | 17 | 125 |
| 22 | C-22 | A-8 | Added | 18 | 125 |
| 23 | C-23 | A-8 | Added | 18 | 125 |
| 24 | C-24 | A-8 | Added | 18 | 125 |
| 25 | C-25 | A-8 | Added | 18 | 125 |
| 26 | C-26 | A-8 | Added | 19 | 125 |
| 27 | C-27 | A-8 | Added | 19 | 125 |
| 28 | C-28 | A-8 | Added | 16 | 125 |
| 29 | C-29 | A-8 | Added | 16 | 125 |
| 30 | C-30 | A-8 | Added | 16 | 125 |
| 31 | C-31 | A-8 | Added | 17 | 125 |
| 32 | C-32 | A-8 | Added | 19 | 125 |
| 33 | C-33 | A-8 | Added | 18 | 125 |
| 34 | C-34 | A-8 | Added | 18 | 125 |
| 35 | C-35 | A-8 | Added | 18 | 125 |
| 36 | C-36 | A-8 | Added | 18 | 125 |
| 37 | C-37 | A-8 | Added | 18 | 125 |
| 38 | C-38 | A-8 | Added | 18 | 125 |
| 39 | C-39 | A-8 | Added | 19 | 125 |
| 40 | C-40 | A-8 | Added | 19 | 125 |
| 41 | C-41 | A-8 | Added | 19 | 125 |
| 42 | C-42 | A-8 | Added | 19 | 125 |
| 43 | C-43 | A-8 | Added | 19 | 125 |
| 44 | C-44 | A-8 | Added | 19 | 125 |
| 45 | C-45 | A-8 | Added | 19 | 125 |
| 46 | C-46 | A-8 | Added | 19 | 125 |
| 47 | C-47 | A-8 | Added | 19 | 125 |
| 48 | C-48 | A-8 | Added | 19 | 125 |
| 49 | C-49 | A-8 | Added | 19 | 125 |
| 50 | C-50 | A-8 | Added | 19 | 125 |
| 51 | C-51 | A-8 | Added | 19 | 125 |
| 52 | C-52 | A-8 | Added | 26 | 200 |
| 53 | C-53 | A-8 | Added | 25 | 200 |
| 54 | C-54 | A-8 | Added | 25 | 190 |
| 55 | C-55 | A-8 | Added | 24 | 185 |

TABLE 2

| | | | | Power | Playback |
|---|---|---|---|---|---|
| Sample | | | | margin | durability |
| No. | Cation | Anion | Quencher | (%) | (×10,000 times) |
| 1 | C-1 | A-7 | Added | 16 | 110 |
| 2 | C-2 | A-7 | Added | 16 | 110 |
| 3 | C-3 | A-7 | Added | 17 | 110 |
| 4 | C-4 | A-7 | Added | 16 | 125 |
| 5 | C-5 | A-7 | Added | 16 | 110 |
| 6 | C-6 | A-7 | Added | 16 | 110 |
| 7 | C-7 | A-7 | Added | 16 | 110 |
| 8 | C-8 | A-7 | Added | 16 | 110 |
| 9 | C-9 | A-7 | Added | 16 | 110 |
| 10 | C-10 | A-7 | Added | 16 | 110 |
| 11 | C-11 | A-7 | Added | 16 | 110 |
| 12 | C-12 | A-7 | Added | 16 | 110 |
| 13 | C-13 | A-7 | Added | 16 | 110 |
| 14 | C-14 | A-7 | Added | 16 | 110 |
| 15 | C-15 | A-7 | Added | 16 | 110 |
| 16 | C-16 | A-7 | Added | 16 | 110 |
| 17 | C-17 | A-7 | Added | 16 | 110 |
| 18 | C-18 | A-7 | Added | 16 | 110 |
| 19 | C-19 | A-7 | Added | 16 | 110 |
| 20 | C-20 | A-7 | Added | 16 | 105 |
| 21 | C-21 | A-7 | Added | 16 | 105 |
| 22 | C-22 | A-7 | Added | 16 | 105 |
| 23 | C-23 | A-7 | Added | 16 | 105 |
| 24 | C-24 | A-7 | Added | 16 | 105 |
| 25 | C-25 | A-7 | Added | 16 | 105 |
| 26 | C-26 | A-7 | Added | 16 | 105 |
| 27 | C-27 | A-7 | Added | 16 | 105 |
| 28 | C-28 | A-7 | Added | 16 | 105 |
| 29 | C-29 | A-7 | Added | 16 | 105 |
| 30 | C-30 | A-7 | Added | 16 | 105 |
| 31 | C-31 | A-7 | Added | 16 | 105 |
| 32 | C-32 | A-7 | Added | 16 | 105 |
| 33 | C-33 | A-7 | Added | 16 | 105 |
| 34 | C-34 | A-7 | Added | 16 | 105 |
| 35 | C-35 | A-7 | Added | 16 | 105 |
| 36 | C-36 | A-7 | Added | 16 | 105 |
| 37 | C-37 | A-7 | Added | 16 | 105 |
| 38 | C-38 | A-7 | Added | 16 | 105 |
| 39 | C-39 | A-7 | Added | 16 | 105 |
| 40 | C-40 | A-7 | Added | 16 | 105 |
| 41 | C-41 | A-7 | Added | 16 | 105 |
| 42 | C-42 | A-7 | Added | 16 | 105 |
| 43 | C-43 | A-7 | Added | 16 | 105 |
| 44 | C-44 | A-7 | Added | 16 | 105 |
| 45 | C-45 | A-7 | Added | 16 | 105 |
| 46 | C-46 | A-7 | Added | 16 | 105 |
| 47 | C-47 | A-7 | Added | 16 | 105 |
| 48 | C-48 | A-7 | Added | 16 | 105 |
| 49 | C-49 | A-7 | Added | 16 | 105 |
| 50 | C-50 | A-7 | Added | 16 | 105 |
| 51 | C-51 | A-7 | Added | 16 | 105 |
| 52 | C-52 | A-7 | Added | 25 | 200 |
| 53 | C-53 | A-7 | Added | 24 | 200 |
| 54 | C-54 | A-7 | Added | 24 | 190 |
| 55 | C-55 | A-7 | Added | 23 | 185 |

TABLE 3

| | | | | Power | Playback |
|---|---|---|---|---|---|
| Sample | | | | margin | durability |
| No. | Cation | Anion | Quencher | (%) | (×10,000 times) |
| 1 | C-1 | A-6 | Added | 19 | 130 |
| 2 | C-2 | A-6 | Added | 19 | 120 |
| 3 | C-3 | A-6 | Added | 18 | 130 |
| 4 | C-4 | A-6 | Added | 19 | 120 |
| 5 | C-5 | A-6 | Added | 19 | 125 |
| 6 | C-6 | A-6 | Added | 18 | 120 |
| 7 | C-7 | A-6 | Added | 19 | 110 |
| 8 | C-8 | A-6 | Added | 19 | 125 |
| 9 | C-9 | A-6 | Added | 20 | 120 |
| 10 | C-10 | A-6 | Added | 20 | 125 |
| 11 | C-11 | A-6 | Added | 19 | 125 |
| 12 | C-12 | A-6 | Added | 18 | 125 |
| 13 | C-13 | A-6 | Added | 18 | 125 |
| 14 | C-14 | A-6 | Added | 17 | 125 |
| 15 | C-15 | A-6 | Added | 17 | 125 |
| 16 | C-16 | A-6 | Added | 16 | 125 |
| 17 | C-17 | A-6 | Added | 17 | 125 |
| 18 | C-18 | A-6 | Added | 16 | 125 |
| 19 | C-19 | A-6 | Added | 17 | 125 |
| 20 | C-20 | A-6 | Added | 17 | 125 |
| 21 | C-21 | A-6 | Added | 17 | 125 |
| 22 | C-22 | A-6 | Added | 18 | 125 |
| 23 | C-23 | A-6 | Added | 19 | 110 |
| 24 | C-24 | A-6 | Added | 19 | 110 |
| 25 | C-25 | A-6 | Added | 19 | 110 |
| 26 | C-26 | A-6 | Added | 19 | 110 |
| 27 | C-27 | A-6 | Added | 19 | 110 |
| 28 | C-28 | A-6 | Added | 17 | 110 |
| 29 | C-29 | A-6 | Added | 17 | 110 |
| 30 | C-30 | A-6 | Added | 16 | 110 |
| 31 | C-31 | A-6 | Added | 17 | 110 |
| 32 | C-32 | A-6 | Added | 16 | 110 |
| 33 | C-33 | A-6 | Added | 16 | 110 |
| 34 | C-34 | A-6 | Added | 16 | 110 |
| 35 | C-35 | A-6 | Added | 16 | 110 |
| 36 | C-36 | A-6 | Added | 16 | 110 |
| 37 | C-37 | A-6 | Added | 16 | 110 |
| 38 | C-38 | A-6 | Added | 16 | 110 |
| 39 | C-39 | A-6 | Added | 17 | 110 |
| 40 | C-40 | A-6 | Added | 17 | 110 |
| 41 | C-41 | A-6 | Added | 17 | 110 |
| 42 | C-42 | A-6 | Added | 17 | 110 |
| 43 | C-43 | A-6 | Added | 17 | 110 |
| 44 | C-44 | A-6 | Added | 17 | 110 |
| 45 | C-45 | A-6 | Added | 17 | 110 |
| 46 | C-46 | A-6 | Added | 17 | 110 |
| 47 | C-47 | A-6 | Added | 17 | 110 |
| 48 | C-48 | A-6 | Added | 17 | 110 |
| 49 | C-49 | A-6 | Added | 17 | 110 |
| 50 | C-50 | A-6 | Added | 17 | 110 |
| 51 | C-51 | A-6 | Added | 17 | 110 |
| 52 | C-52 | A-6 | Added | 23 | 200 |
| 53 | C-53 | A-6 | Added | 22 | 200 |
| 54 | C-54 | A-6 | Added | 22 | 190 |
| 55 | C-55 | A-6 | Added | 22 | 185 |

TABLE 4

| | | | | Power | Playback |
|---|---|---|---|---|---|
| Sample | | | | margin | durability |
| No. | Cation | Anion | Quencher | (%) | (×10,000 times) |
| 1 | C-1 | A-5 | Added | 17 | 120 |
| 2 | C-2 | A-5 | Added | 17 | 110 |
| 3 | C-3 | A-5 | Added | 17 | 110 |
| 4 | C-4 | A-5 | Added | 16 | 125 |
| 5 | C-5 | A-5 | Added | 16 | 110 |
| 6 | C-6 | A-5 | Added | 16 | 110 |
| 7 | C-7 | A-5 | Added | 16 | 110 |
| 8 | C-8 | A-5 | Added | 16 | 110 |
| 9 | C-9 | A-5 | Added | 16 | 110 |
| 10 | C-10 | A-5 | Added | 16 | 110 |
| 11 | C-11 | A-5 | Added | 16 | 110 |
| 12 | C-12 | A-5 | Added | 16 | 110 |
| 13 | C-13 | A-5 | Added | 16 | 110 |
| 14 | C-14 | A-5 | Added | 16 | 110 |
| 15 | C-15 | A-5 | Added | 16 | 110 |
| 16 | C-16 | A-5 | Added | 16 | 110 |
| 17 | C-17 | A-5 | Added | 16 | 110 |
| 18 | C-18 | A-5 | Added | 16 | 110 |
| 19 | C-19 | A-5 | Added | 16 | 110 |
| 20 | C-20 | A-5 | Added | 16 | 110 |
| 21 | C-21 | A-5 | Added | 16 | 110 |
| 22 | C-22 | A-5 | Added | 16 | 110 |
| 23 | C-23 | A-5 | Added | 16 | 110 |
| 24 | C-24 | A-5 | Added | 16 | 110 |
| 25 | C-25 | A-5 | Added | 16 | 110 |
| 26 | C-26 | A-5 | Added | 16 | 110 |
| 27 | C-27 | A-5 | Added | 16 | 110 |
| 28 | C-28 | A-5 | Added | 16 | 110 |
| 29 | C-29 | A-5 | Added | 16 | 110 |
| 30 | C-30 | A-5 | Added | 16 | 110 |
| 31 | C-31 | A-5 | Added | 16 | 110 |
| 32 | C-32 | A-5 | Added | 16 | 110 |
| 33 | C-33 | A-5 | Added | 16 | 110 |
| 34 | C-34 | A-5 | Added | 16 | 110 |
| 35 | C-35 | A-5 | Added | 16 | 110 |
| 36 | C-36 | A-5 | Added | 16 | 110 |
| 37 | C-37 | A-5 | Added | 16 | 110 |
| 38 | C-38 | A-5 | Added | 16 | 110 |
| 39 | C-39 | A-5 | Added | 16 | 110 |
| 40 | C-40 | A-5 | Added | 16 | 110 |
| 41 | C-41 | A-5 | Added | 16 | 110 |
| 42 | C-42 | A-5 | Added | 16 | 110 |
| 43 | C-43 | A-5 | Added | 16 | 110 |
| 44 | C-44 | A-5 | Added | 16 | 110 |
| 45 | C-45 | A-5 | Added | 16 | 110 |
| 46 | C-46 | A-5 | Added | 16 | 110 |
| 47 | C-47 | A-5 | Added | 16 | 110 |
| 48 | C-48 | A-5 | Added | 16 | 110 |
| 49 | C-49 | A-5 | Added | 16 | 110 |
| 50 | C-50 | A-5 | Added | 16 | 110 |
| 51 | C-51 | A-5 | Added | 16 | 110 |
| 52 | C-52 | A-5 | Added | 21 | 190 |
| 53 | C-53 | A-5 | Added | 20 | 180 |
| 54 | C-54 | A-5 | Added | 20 | 185 |
| 55 | C-55 | A-5 | Added | 20 | 190 |

TABLE 5

| | | | | Power | Playback |
|---|---|---|---|---|---|
| | | | | margin | durability |
| Sample No. | Cation | Anion | Quencher | (%) | (×10,000 times) |
| 1 | C-1 | A-4 | Added | 19 | 120 |
| 2 | C-2 | A-4 | Added | 19 | 110 |
| 3 | C-3 | A-4 | Added | 17 | 130 |
| 4 | C-4 | A-4 | Added | 18 | 120 |
| 5 | C-5 | A-4 | Added | 18 | 110 |
| 6 | C-6 | A-4 | Added | 18 | 110 |
| 7 | C-7 | A-4 | Added | 18 | 110 |
| 8 | C-8 | A-4 | Added | 19 | 110 |
| 9 | C-9 | A-4 | Added | 18 | 110 |
| 10 | C-10 | A-4 | Added | 18 | 110 |
| 11 | C-11 | A-4 | Added | 19 | 110 |
| 12 | C-12 | A-4 | Added | 18 | 110 |
| 13 | C-13 | A-4 | Added | 18 | 110 |
| 14 | C-14 | A-4 | Added | 16 | 110 |
| 15 | C-15 | A-4 | Added | 16 | 110 |
| 16 | C-16 | A-4 | Added | 16 | 110 |
| 17 | C-17 | A-4 | Added | 17 | 110 |
| 18 | C-18 | A-4 | Added | 16 | 110 |
| 19 | C-19 | A-4 | Added | 17 | 110 |
| 20 | C-20 | A-4 | Added | 17 | 110 |
| 21 | C-21 | A-4 | Added | 17 | 110 |
| 22 | C-22 | A-4 | Added | 18 | 110 |
| 23 | C-23 | A-4 | Added | 18 | 110 |
| 24 | C-24 | A-4 | Added | 18 | 110 |
| 25 | C-25 | A-4 | Added | 17 | 110 |
| 26 | C-26 | A-4 | Added | 17 | 110 |
| 27 | C-27 | A-4 | Added | 17 | 110 |
| 28 | C-28 | A-4 | Added | 16 | 110 |
| 29 | C-29 | A-4 | Added | 16 | 110 |
| 30 | C-30 | A-4 | Added | 16 | 110 |
| 31 | C-31 | A-4 | Added | 17 | 110 |
| 32 | C-32 | A-4 | Added | 16 | 110 |
| 33 | C-33 | A-4 | Added | 16 | 110 |
| 34 | C-34 | A-4 | Added | 16 | 110 |
| 35 | C-35 | A-4 | Added | 16 | 110 |
| 36 | C-36 | A-4 | Added | 16 | 110 |
| 37 | C-37 | A-4 | Added | 16 | 110 |
| 38 | C-38 | A-4 | Added | 16 | 110 |
| 39 | C-39 | A-4 | Added | 16 | 110 |
| 40 | C-40 | A-4 | Added | 16 | 110 |
| 41 | C-41 | A-4 | Added | 16 | 110 |
| 42 | C-42 | A-4 | Added | 16 | 110 |
| 43 | C-43 | A-4 | Added | 16 | 110 |
| 44 | C-44 | A-4 | Added | 16 | 110 |
| 45 | C-45 | A-4 | Added | 16 | 110 |
| 46 | C-46 | A-4 | Added | 16 | 110 |
| 47 | C-47 | A-4 | Added | 16 | 110 |
| 48 | C-48 | A-4 | Added | 16 | 110 |
| 49 | C-49 | A-4 | Added | 16 | 110 |
| 50 | C-50 | A-4 | Added | 16 | 110 |
| 51 | C-51 | A-4 | Added | 16 | 110 |
| 52 | C-52 | A-4 | Added | 20 | 190 |
| 53 | C-53 | A-4 | Added | 21 | 180 |
| 54 | C-54 | A-4 | Added | 21 | 185 |
| 55 | C-55 | A-4 | Added | 22 | 190 |

TABLE 6

| | | | | Power | Playback |
|---|---|---|---|---|---|
| | | | | margin | durability |
| Sample No. | Cation | Anion | Quencher | (%) | (×10,000 times) |
| 1 | C-1 | A-3 | Added | 19 | 130 |
| 2 | C-2 | A-3 | Added | 19 | 120 |
| 3 | C-3 | A-3 | Added | 18 | 130 |
| 4 | C-4 | A-3 | Added | 18 | 120 |
| 5 | C-5 | A-3 | Added | 18 | 130 |
| 6 | C-6 | A-3 | Added | 19 | 130 |
| 7 | C-7 | A-3 | Added | 19 | 130 |
| 8 | C-8 | A-3 | Added | 19 | 130 |
| 9 | C-9 | A-3 | Added | 19 | 130 |
| 10 | C-10 | A-3 | Added | 19 | 130 |
| 11 | C-11 | A-3 | Added | 19 | 130 |
| 12 | C-12 | A-3 | Added | 21 | 130 |
| 13 | C-13 | A-3 | Added | 21 | 130 |
| 14 | C-14 | A-3 | Added | 18 | 130 |
| 15 | C-15 | A-3 | Added | 18 | 130 |
| 16 | C-16 | A-3 | Added | 18 | 130 |
| 17 | C-17 | A-3 | Added | 17 | 130 |
| 18 | C-18 | A-3 | Added | 16 | 130 |
| 19 | C-19 | A-3 | Added | 18 | 130 |
| 20 | C-20 | A-3 | Added | 18 | 130 |
| 21 | C-21 | A-3 | Added | 18 | 130 |
| 22 | C-22 | A-3 | Added | 18 | 130 |
| 23 | C-23 | A-3 | Added | 18 | 130 |
| 24 | C-24 | A-3 | Added | 18 | 130 |
| 25 | C-25 | A-3 | Added | 18 | 130 |
| 26 | C-26 | A-3 | Added | 19 | 130 |
| 27 | C-27 | A-3 | Added | 19 | 130 |
| 28 | C-28 | A-3 | Added | 16 | 130 |
| 29 | C-29 | A-3 | Added | 16 | 130 |
| 30 | C-30 | A-3 | Added | 16 | 130 |
| 31 | C-31 | A-3 | Added | 17 | 130 |
| 32 | C-32 | A-3 | Added | 18 | 130 |
| 33 | C-33 | A-3 | Added | 18 | 130 |
| 34 | C-34 | A-3 | Added | 18 | 130 |
| 35 | C-35 | A-3 | Added | 18 | 130 |
| 36 | C-36 | A-3 | Added | 18 | 130 |
| 37 | C-37 | A-3 | Added | 18 | 130 |
| 38 | C-38 | A-3 | Added | 18 | 130 |
| 39 | C-39 | A-3 | Added | 18 | 130 |
| 40 | C-40 | A-3 | Added | 18 | 130 |
| 41 | C-41 | A-3 | Added | 18 | 130 |
| 42 | C-42 | A-3 | Added | 18 | 130 |
| 43 | C-43 | A-3 | Added | 18 | 130 |
| 44 | C-44 | A-3 | Added | 18 | 130 |
| 45 | C-45 | A-3 | Added | 18 | 130 |
| 46 | C-46 | A-3 | Added | 18 | 130 |
| 47 | C-47 | A-3 | Added | 18 | 130 |
| 48 | C-48 | A-3 | Added | 18 | 130 |
| 49 | C-49 | A-3 | Added | 18 | 130 |
| 50 | C-50 | A-3 | Added | 18 | 130 |
| 51 | C-51 | A-3 | Added | 18 | 130 |
| 52 | C-52 | A-3 | Added | 26 | 210 |
| 53 | C-53 | A-3 | Added | 22 | 190 |
| 54 | C-54 | A-3 | Added | 22 | 195 |
| 55 | C-55 | A-3 | Added | 20 | 195 |

TABLE 7

| | | | | Power | Playback |
|---|---|---|---|---|---|
| | | | | margin | durability |
| Sample No. | Cation | Anion | Quencher | (%) | (×10,000 times) |
| 1 | C-1 | A-2 | Added | 19 | 120 |
| 2 | C-2 | A-2 | Added | 19 | 110 |
| 3 | C-3 | A-2 | Added | 18 | 130 |
| 4 | C-4 | A-2 | Added | 18 | 120 |
| 5 | C-5 | A-2 | Added | 18 | 125 |
| 6 | C-6 | A-2 | Added | 19 | 125 |
| 7 | C-7 | A-2 | Added | 19 | 125 |
| 8 | C-8 | A-2 | Added | 19 | 125 |
| 9 | C-9 | A-2 | Added | 19 | 125 |
| 10 | C-10 | A-2 | Added | 19 | 125 |
| 11 | C-11 | A-2 | Added | 19 | 125 |
| 12 | C-12 | A-2 | Added | 20 | 125 |
| 13 | C-13 | A-2 | Added | 20 | 125 |
| 14 | C-14 | A-2 | Added | 18 | 125 |
| 15 | C-15 | A-2 | Added | 18 | 125 |
| 16 | C-16 | A-2 | Added | 18 | 125 |
| 17 | C-17 | A-2 | Added | 17 | 125 |
| 18 | C-18 | A-2 | Added | 16 | 125 |
| 19 | C-19 | A-2 | Added | 17 | 125 |
| 20 | C-20 | A-2 | Added | 17 | 125 |
| 21 | C-21 | A-2 | Added | 17 | 125 |
| 22 | C-22 | A-2 | Added | 18 | 125 |
| 23 | C-23 | A-2 | Added | 18 | 125 |
| 24 | C-24 | A-2 | Added | 18 | 125 |
| 25 | C-25 | A-2 | Added | 18 | 125 |
| 26 | C-26 | A-2 | Added | 19 | 125 |
| 27 | C-27 | A-2 | Added | 19 | 125 |
| 28 | C-28 | A-2 | Added | 16 | 125 |
| 29 | C-29 | A-2 | Added | 16 | 125 |
| 30 | C-30 | A-2 | Added | 16 | 125 |
| 31 | C-31 | A-2 | Added | 17 | 125 |
| 32 | C-32 | A-2 | Added | 18 | 125 |
| 33 | C-33 | A-2 | Added | 18 | 125 |
| 34 | C-34 | A-2 | Added | 18 | 125 |
| 35 | C-35 | A-2 | Added | 18 | 125 |
| 36 | C-36 | A-2 | Added | 18 | 125 |
| 37 | C-37 | A-2 | Added | 18 | 125 |
| 38 | C-38 | A-2 | Added | 18 | 125 |
| 39 | C-39 | A-2 | Added | 18 | 125 |
| 40 | C-40 | A-2 | Added | 18 | 125 |
| 41 | C-41 | A-2 | Added | 18 | 125 |
| 42 | C-42 | A-2 | Added | 18 | 125 |
| 43 | C-43 | A-2 | Added | 18 | 125 |
| 44 | C-44 | A-2 | Added | 18 | 125 |
| 45 | C-45 | A-2 | Added | 18 | 125 |
| 46 | C-46 | A-2 | Added | 18 | 125 |
| 47 | C-47 | A-2 | Added | 18 | 125 |
| 48 | C-48 | A-2 | Added | 18 | 125 |
| 49 | C-49 | A-2 | Added | 18 | 125 |
| 50 | C-50 | A-2 | Added | 18 | 125 |
| 51 | C-51 | A-2 | Added | 18 | 125 |
| 52 | C-52 | A-2 | Added | 27 | 210 |
| 53 | C-53 | A-2 | Added | 24 | 190 |
| 54 | C-54 | A-2 | Added | 25 | 195 |
| 55 | C-55 | A-2 | Added | 26 | 195 |

TABLE 8

| | | | | Power | Playback |
|---|---|---|---|---|---|
| | | | | margin | durability |
| Sample No. | Cation | Anion | Quencher | (%) | (×10,000 times) |
| 1 | C-1 | A-1 | Added | 18 | 120 |
| 2 | C-2 | A-1 | Added | 18 | 110 |
| 3 | C-3 | A-1 | Added | 17 | 130 |
| 4 | C-4 | A-1 | Added | 19 | 120 |
| 5 | C-5 | A-1 | Added | 19 | 125 |
| 6 | C-6 | A-1 | Added | 18 | 125 |
| 7 | C-7 | A-1 | Added | 19 | 125 |
| 8 | C-8 | A-1 | Added | 19 | 125 |
| 9 | C-9 | A-1 | Added | 20 | 125 |
| 10 | C-10 | A-1 | Added | 20 | 125 |
| 11 | C-11 | A-1 | Added | 19 | 125 |
| 12 | C-12 | A-1 | Added | 18 | 125 |
| 13 | C-13 | A-1 | Added | 18 | 125 |
| 14 | C-14 | A-1 | Added | 17 | 125 |
| 15 | C-15 | A-1 | Added | 17 | 125 |
| 16 | C-16 | A-1 | Added | 16 | 125 |
| 17 | C-17 | A-1 | Added | 17 | 125 |
| 18 | C-18 | A-1 | Added | 16 | 125 |
| 19 | C-19 | A-1 | Added | 17 | 125 |
| 20 | C-20 | A-1 | Added | 17 | 125 |
| 21 | C-21 | A-1 | Added | 17 | 125 |
| 22 | C-22 | A-1 | Added | 18 | 125 |
| 23 | C-23 | A-1 | Added | 19 | 125 |
| 24 | C-24 | A-1 | Added | 19 | 125 |
| 25 | C-25 | A-1 | Added | 19 | 125 |
| 26 | C-26 | A-1 | Added | 19 | 125 |
| 27 | C-27 | A-1 | Added | 19 | 125 |
| 28 | C-28 | A-1 | Added | 16 | 125 |
| 29 | C-29 | A-1 | Added | 16 | 125 |
| 30 | C-30 | A-1 | Added | 16 | 125 |
| 31 | C-31 | A-1 | Added | 17 | 125 |
| 32 | C-32 | A-1 | Added | 16 | 125 |
| 33 | C-33 | A-1 | Added | 16 | 125 |
| 34 | C-34 | A-1 | Added | 16 | 125 |
| 35 | C-35 | A-1 | Added | 16 | 125 |
| 36 | C-36 | A-1 | Added | 16 | 125 |
| 37 | C-37 | A-1 | Added | 16 | 125 |
| 38 | C-38 | A-1 | Added | 16 | 125 |
| 39 | C-39 | A-1 | Added | 16 | 125 |
| 40 | C-40 | A-1 | Added | 16 | 125 |
| 41 | C-41 | A-1 | Added | 16 | 125 |
| 42 | C-42 | A-1 | Added | 16 | 125 |
| 43 | C-43 | A-1 | Added | 16 | 125 |
| 44 | C-44 | A-1 | Added | 16 | 125 |
| 45 | C-45 | A-1 | Added | 16 | 125 |
| 46 | C-46 | A-1 | Added | 16 | 125 |
| 47 | C-47 | A-1 | Added | 16 | 125 |
| 48 | C-48 | A-1 | Added | 16 | 125 |
| 49 | C-49 | A-1 | Added | 16 | 125 |
| 50 | C-50 | A-1 | Added | 16 | 125 |
| 51 | C-51 | A-1 | Added | 16 | 125 |
| 52 | C-52 | A-1 | Added | 25 | 200 |
| 53 | C-53 | A-1 | Added | 23 | 190 |
| 54 | C-54 | A-1 | Added | 24 | 195 |
| 55 | C-55 | A-1 | Added | 26 | 195 |

TABLE 9

| | | | | Power | Playback |
|---|---|---|---|---|---|
| | | | | margin | durability |
| Sample No. | Cation | Anion | Quencher | (%) | (×10,000 times) |
| 1 | C-1 | A-8 | Not | 20 | 15 |
| | | | added | | |
| 2 | C-2 | A-8 | Not | 19 | 15 |
| | | | added | | |
| 3 | C-3 | A-8 | Not | 20 | 15 |
| | | | added | | |
| 4 | C-4 | A-8 | Not | 18 | 15 |
| | | | added | | |
| 5 | C-5 | A-8 | Not | 18 | 15 |
| | | | added | | |
| 6 | C-6 | A-8 | Not | 19 | 15 |
| | | | added | | |
| 7 | C-7 | A-8 | Not | 19 | 15 |
| | | | added | | |
| 8 | C-8 | A-8 | Not | 19 | 15 |
| | | | added | | |
| 9 | C-9 | A-8 | Not | 19 | 15 |
| | | | added | | |
| 10 | C-10 | A-8 | Not | 19 | 15 |
| | | | added | | |
| 11 | C-11 | A-8 | Not | 19 | 15 |
| | | | added | | |
| 12 | C-12 | A-8 | Not | 20 | 15 |
| | | | added | | |
| 13 | C-13 | A-8 | Not | 20 | 20 |
| | | | added | | |
| 14 | C-14 | A-8 | Not | 18 | 22 |
| | | | added | | |
| 15 | C-15 | A-8 | Not | 18 | 22 |
| | | | added | | |
| 16 | C-16 | A-8 | Not | 18 | 22 |
| | | | added | | |
| 17 | C-17 | A-8 | Not | 17 | 22 |
| | | | added | | |
| 18 | C-18 | A-8 | Not | 16 | 22 |
| | | | added | | |
| 19 | C-19 | A-8 | Not | 17 | 22 |
| | | | added | | |
| 20 | C-20 | A-8 | Not | 17 | 22 |
| | | | added | | |
| 21 | C-21 | A-8 | Not | 17 | 22 |
| | | | added | | |
| 22 | C-22 | A-8 | Not | 18 | 30 |
| | | | added | | |
| 23 | C-23 | A-8 | Not | 18 | 30 |
| | | | added | | |
| 24 | C-24 | A-8 | Not | 18 | 30 |
| | | | added | | |
| 25 | C-25 | A-8 | Not | 18 | 30 |
| | | | added | | |
| 26 | C-26 | A-8 | Not | 19 | 30 |
| | | | added | | |
| 27 | C-27 | A-8 | Not | 19 | 30 |
| | | | added | | |
| 28 | C-28 | A-8 | Not | 16 | 30 |
| | | | added | | |
| 29 | C-29 | A-8 | Not | 16 | 30 |
| | | | added | | |
| 30 | C-30 | A-8 | Not | 16 | 30 |
| | | | added | | |
| 31 | C-31 | A-8 | Not | 17 | 30 |
| | | | added | | |
| 32 | C-32 | A-8 | Not | 19 | 30 |
| | | | added | | |
| 33 | C-33 | A-8 | Not | 18 | 30 |
| | | | added | | |
| 34 | C-34 | A-8 | Not | 18 | 30 |
| | | | added | | |
| 35 | C-35 | A-8 | Not | 18 | 30 |
| | | | added | | |
| 36 | C-36 | A-8 | Not | 18 | 30 |
| | | | added | | |
| 37 | C-37 | A-8 | Not | 18 | 30 |
| | | | added | | |
| 38 | C-38 | A-8 | Not | 18 | 30 |
| | | | added | | |
| 39 | C-39 | A-8 | Not | 19 | 30 |
| | | | added | | |
| 40 | C-40 | A-8 | Not | 19 | 30 |
| | | | added | | |
| 41 | C-41 | A-8 | Not | 19 | 30 |
| | | | added | | |
| 42 | C-42 | A-8 | Not | 19 | 30 |
| | | | added | | |
| 43 | C-43 | A-8 | Not | 19 | 30 |
| | | | added | | |
| 44 | C-44 | A-8 | Not | 19 | 30 |
| | | | added | | |
| 45 | C-45 | A-8 | Not | 19 | 22 |
| | | | added | | |
| 46 | C-46 | A-8 | Not | 19 | 22 |
| | | | added | | |
| 47 | C-47 | A-8 | Not | 19 | 21 |
| | | | added | | |
| 48 | C-48 | A-8 | Not | 19 | 19 |
| | | | added | | |
| 49 | C-49 | A-8 | Not | 19 | 19 |
| | | | added | | |
| 50 | C-50 | A-8 | Not | 19 | 19 |
| | | | added | | |
| 51 | C-51 | A-8 | Not | 19 | 18 |
| | | | added | | |
| 52 | C-52 | A-8 | Not | 26 | 28 |
| | | | added | | |
| 53 | C-53 | A-8 | Not | 25 | 30 |
| | | | added | | |
| 54 | C-54 | A-8 | Not | 25 | 30 |
| | | | added | | |
| 55 | C-55 | A-8 | Not | 24 | 21 |
| | | | added | | |

TABLE 10

| | | | | Power | Playback |
|---|---|---|---|---|---|
| | | | | margin | durability |
| Sample No. | Cation | Anion | Quencher | (%) | (×10,000 times) |
| 1 | C-1 | A-7 | Not | 16 | 45 |
| | | | added | | |
| 2 | C-2 | A-7 | Not | 16 | 40 |
| | | | added | | |
| 3 | C-3 | A-7 | Not | 17 | 40 |
| | | | added | | |
| 4 | C-4 | A-7 | Not | 16 | 40 |
| | | | added | | |
| 5 | C-5 | A-7 | Not | 16 | 40 |
| | | | added | | |
| 6 | C-6 | A-7 | Not | 16 | 40 |
| | | | added | | |
| 7 | C-7 | A-7 | Not | 16 | 40 |
| | | | added | | |
| 8 | C-8 | A-7 | Not | 16 | 40 |
| | | | added | | |
| 9 | C-9 | A-7 | Not | 16 | 40 |
| | | | added | | |
| 10 | C-10 | A-7 | Not | 16 | 40 |
| | | | added | | |
| 11 | C-11 | A-7 | Not | 16 | 40 |
| | | | added | | |
| 12 | C-12 | A-7 | Not | 16 | 40 |
| | | | added | | |
| 13 | C-13 | A-7 | Not | 16 | 40 |
| | | | added | | |
| 14 | C-14 | A-7 | Not | 16 | 40 |
| | | | added | | |
| 15 | C-15 | A-7 | Not | 16 | 40 |
| | | | added | | |
| 16 | C-16 | A-7 | Not | 16 | 40 |
| | | | added | | |
| 17 | C-17 | A-7 | Not | 16 | 40 |
| | | | added | | |
| 18 | C-18 | A-7 | Not | 16 | 40 |
| | | | added | | |
| 19 | C-19 | A-7 | Not | 16 | 40 |
| | | | added | | |
| 20 | C-20 | A-7 | Not | 16 | 40 |
| | | | added | | |
| 21 | C-21 | A-7 | Not | 16 | 40 |
| | | | added | | |
| 22 | C-22 | A-7 | Not | 16 | 40 |
| | | | added | | |
| 23 | C-23 | A-7 | Not | 16 | 40 |
| | | | added | | |
| 24 | C-24 | A-7 | Not | 16 | 40 |
| | | | added | | |
| 25 | C-25 | A-7 | Not | 16 | 40 |
| | | | added | | |
| 26 | C-26 | A-7 | Not | 16 | 40 |
| | | | added | | |
| 27 | C-27 | A-7 | Not | 16 | 40 |
| | | | added | | |
| 28 | C-28 | A-7 | Not | 16 | 40 |
| | | | added | | |
| 29 | C-29 | A-7 | Not | 16 | 42 |
| | | | added | | |
| 30 | C-30 | A-7 | Not | 16 | 42 |
| | | | added | | |
| 31 | C-31 | A-7 | Not | 16 | 42 |
| | | | added | | |
| 32 | C-32 | A-7 | Not | 16 | 42 |
| | | | added | | |
| 33 | C-33 | A-7 | Not | 16 | 42 |
| | | | added | | |
| 34 | C-34 | A-7 | Not | 16 | 42 |
| | | | added | | |
| 35 | C-35 | A-7 | Not | 16 | 42 |
| | | | added | | |
| 36 | C-36 | A-7 | Not | 16 | 42 |
| | | | added | | |
| 37 | C-37 | A-7 | Not | 16 | 42 |
| | | | added | | |
| 38 | C-38 | A-7 | Not | 16 | 42 |
| | | | added | | |
| 39 | C-39 | A-7 | Not | 16 | 42 |
| | | | added | | |
| 40 | C-40 | A-7 | Not | 16 | 42 |
| | | | added | | |
| 41 | C-41 | A-7 | Not | 16 | 42 |
| | | | added | | |
| 42 | C-42 | A-7 | Not | 16 | 42 |
| | | | added | | |
| 43 | C-43 | A-7 | Not | 16 | 42 |
| | | | added | | |
| 44 | C-44 | A-7 | Not | 16 | 42 |
| | | | added | | |
| 45 | C-45 | A-7 | Not | 16 | 42 |
| | | | added | | |
| 46 | C-46 | A-7 | Not | 16 | 42 |
| | | | added | | |
| 47 | C-47 | A-7 | Not | 16 | 30 |
| | | | added | | |
| 48 | C-48 | A-7 | Not | 16 | 30 |
| | | | added | | |
| 49 | C-49 | A-7 | Not | 16 | 30 |
| | | | added | | |
| 50 | C-50 | A-7 | Not | 16 | 30 |
| | | | added | | |
| 51 | C-51 | A-7 | Not | 16 | 30 |
| | | | added | | |
| 52 | C-52 | A-7 | Not | 25 | 25 |
| | | | added | | |
| 53 | C-53 | A-7 | Not | 24 | 20 |
| | | | added | | |
| 54 | C-54 | A-7 | Not | 24 | 20 |
| | | | added | | |
| 55 | C-55 | A-7 | Not | 23 | 19 |
| | | | added | | |

TABLE 11

| | | | | Power | Playback |
|---|---|---|---|---|---|
| | | | | margin | durability |
| Sample No. | Cation | Anion | Quencher | (%) | (×10,000 times) |
| 1 | C-1 | A-6 | Not | 19 | 20 |
| | | | added | | |
| 2 | C-2 | A-6 | Not | 19 | 19 |
| | | | added | | |
| 3 | C-3 | A-6 | Not | 18 | 19 |
| | | | added | | |
| 4 | C-4 | A-6 | Not | 19 | 19 |
| | | | added | | |
| 5 | C-5 | A-6 | Not | 19 | 19 |
| | | | added | | |
| 6 | C-6 | A-6 | Not | 18 | 19 |
| | | | added | | |
| 7 | C-7 | A-6 | Not | 19 | 19 |
| | | | added | | |
| 8 | C-8 | A-6 | Not | 19 | 19 |
| | | | added | | |
| 9 | C-9 | A-6 | Not | 20 | 19 |
| | | | added | | |
| 10 | C-10 | A-6 | Not | 20 | 19 |
| | | | added | | |
| 11 | C-11 | A-6 | Not | 19 | 19 |
| | | | added | | |
| 12 | C-12 | A-6 | Not | 18 | 19 |
| | | | added | | |
| 13 | C-13 | A-6 | Not | 18 | 19 |
| | | | added | | |
| 14 | C-14 | A-6 | Not | 17 | 19 |
| | | | added | | |
| 15 | C-15 | A-6 | Not | 17 | 19 |
| | | | added | | |
| 16 | C-16 | A-6 | Not | 16 | 19 |
| | | | added | | |
| 17 | C-17 | A-6 | Not | 17 | 19 |
| | | | added | | |
| 18 | C-18 | A-6 | Not | 16 | 19 |
| | | | added | | |
| 19 | C-19 | A-6 | Not | 17 | 19 |
| | | | added | | |
| 20 | C-20 | A-6 | Not | 17 | 19 |
| | | | added | | |
| 21 | C-21 | A-6 | Not | 17 | 19 |
| | | | added | | |
| 22 | C-22 | A-6 | Not | 18 | 19 |
| | | | added | | |
| 23 | C-23 | A-6 | Not | 19 | 19 |
| | | | added | | |
| 24 | C-24 | A-6 | Not | 19 | 19 |
| | | | added | | |
| 25 | C-25 | A-6 | Not | 19 | 15 |
| | | | added | | |
| 26 | C-26 | A-6 | Not | 19 | 15 |
| | | | added | | |
| 27 | C-27 | A-6 | Not | 19 | 15 |
| | | | added | | |
| 28 | C-28 | A-6 | Not | 17 | 15 |
| | | | added | | |
| 29 | C-29 | A-6 | Not | 17 | 15 |
| | | | added | | |
| 30 | C-30 | A-6 | Not | 16 | 15 |
| | | | added | | |
| 31 | C-31 | A-6 | Not | 17 | 15 |
| | | | added | | |
| 32 | C-32 | A-6 | Not | 16 | 15 |
| | | | added | | |
| 33 | C-33 | A-6 | Not | 16 | 15 |
| | | | added | | |
| 34 | C-34 | A-6 | Not | 16 | 15 |
| | | | added | | |
| 35 | C-35 | A-6 | Not | 16 | 15 |
| | | | added | | |
| 36 | C-36 | A-6 | Not | 16 | 15 |
| | | | added | | |
| 37 | C-37 | A-6 | Not | 16 | 19 |
| | | | added | | |
| 38 | C-38 | A-6 | Not | 16 | 19 |
| | | | added | | |
| 39 | C-39 | A-6 | Not | 17 | 19 |
| | | | added | | |
| 40 | C-40 | A-6 | Not | 17 | 19 |
| | | | added | | |
| 41 | C-41 | A-6 | Not | 17 | 19 |
| | | | added | | |
| 42 | C-42 | A-6 | Not | 17 | 19 |
| | | | added | | |
| 43 | C-43 | A-6 | Not | 17 | 19 |
| | | | added | | |
| 44 | C-44 | A-6 | Not | 17 | 19 |
| | | | added | | |
| 45 | C-45 | A-6 | Not | 17 | 19 |
| | | | added | | |
| 46 | C-46 | A-6 | Not | 17 | 19 |
| | | | added | | |
| 47 | C-47 | A-6 | Not | 17 | 19 |
| | | | added | | |
| 48 | C-48 | A-6 | Not | 17 | 19 |
| | | | added | | |
| 49 | C-49 | A-6 | Not | 17 | 19 |
| | | | added | | |
| 50 | C-50 | A-6 | Not | 17 | 19 |
| | | | added | | |
| 51 | C-51 | A-6 | Not | 17 | 19 |
| | | | added | | |
| 52 | C-52 | A-6 | Not | 23 | 22 |
| | | | added | | |
| 53 | C-53 | A-6 | Not | 22 | 22 |
| | | | added | | |
| 54 | C-54 | A-6 | Not | 22 | 23 |
| | | | added | | |
| 55 | C-55 | A-6 | Not | 22 | 23 |
| | | | added | | |

TABLE 12

| | | | | Power | Playback |
|---|---|---|---|---|---|
| | | | | margin | durability |
| Sample No. | Cation | Anion | Quencher | (%) | (×10,000 times) |
| 1 | C-1 | A-5 | Not | 17 | 30 |
| | | | added | | |
| 2 | C-2 | A-5 | Not | 17 | 30 |
| | | | added | | |
| 3 | C-3 | A-5 | Not | 17 | 24 |
| | | | added | | |
| 4 | C-4 | A-5 | Not | 16 | 22 |
| | | | added | | |
| 5 | C-5 | A-5 | Not | 16 | 20 |
| | | | added | | |
| 6 | C-6 | A-5 | Not | 16 | 20 |
| | | | added | | |
| 7 | C-7 | A-5 | Not | 16 | 20 |
| | | | added | | |
| 8 | C-8 | A-5 | Not | 16 | 20 |
| | | | added | | |
| 9 | C-9 | A-5 | Not | 16 | 20 |
| | | | added | | |
| 10 | C-10 | A-5 | Not | 16 | 20 |
| | | | added | | |
| 11 | C-11 | A-5 | Not | 16 | 20 |
| | | | added | | |
| 12 | C-12 | A-5 | Not | 16 | 20 |
| | | | added | | |
| 13 | C-13 | A-5 | Not | 16 | 20 |
| | | | added | | |
| 14 | C-14 | A-5 | Not | 16 | 19 |
| | | | added | | |
| 15 | C-15 | A-5 | Not | 16 | 19 |
| | | | added | | |
| 16 | C-16 | A-5 | Not | 16 | 19 |
| | | | added | | |
| 17 | C-17 | A-5 | Not | 16 | 19 |
| | | | added | | |
| 18 | C-18 | A-5 | Not | 16 | 19 |
| | | | added | | |
| 19 | C-19 | A-5 | Not | 16 | 19 |
| | | | added | | |
| 20 | C-20 | A-5 | Not | 16 | 19 |
| | | | added | | |
| 21 | C-21 | A-5 | Not | 16 | 19 |
| | | | added | | |
| 22 | C-22 | A-5 | Not | 16 | 10 |
| | | | added | | |
| 23 | C-23 | A-5 | Not | 16 | 10 |
| | | | added | | |
| 24 | C-24 | A-5 | Not | 16 | 10 |
| | | | added | | |
| 25 | C-25 | A-5 | Not | 16 | 10 |
| | | | added | | |
| 26 | C-26 | A-5 | Not | 16 | 10 |
| | | | added | | |
| 27 | C-27 | A-5 | Not | 16 | 10 |
| | | | added | | |
| 28 | C-28 | A-5 | Not | 16 | 10 |
| | | | added | | |
| 29 | C-29 | A-5 | Not | 16 | 10 |
| | | | added | | |
| 30 | C-30 | A-5 | Not | 16 | 10 |
| | | | added | | |
| 31 | C-31 | A-5 | Not | 16 | 10 |
| | | | added | | |
| 32 | C-32 | A-5 | Not | 16 | 10 |
| | | | added | | |
| 33 | C-33 | A-5 | Not | 16 | 10 |
| | | | added | | |
| 34 | C-34 | A-5 | Not | 16 | 10 |
| | | | added | | |
| 35 | C-35 | A-5 | Not | 16 | 10 |
| | | | added | | |
| 36 | C-36 | A-5 | Not | 16 | 10 |
| | | | added | | |
| 37 | C-37 | A-5 | Not | 16 | 10 |
| | | | added | | |
| 38 | C-38 | A-5 | Not | 16 | 10 |
| | | | added | | |
| 39 | C-39 | A-5 | Not | 16 | 10 |
| | | | added | | |
| 40 | C-40 | A-5 | Not | 16 | 10 |
| | | | added | | |
| 41 | C-41 | A-5 | Not | 16 | 10 |
| | | | added | | |
| 42 | C-42 | A-5 | Not | 16 | 10 |
| | | | added | | |
| 43 | C-43 | A-5 | Not | 16 | 10 |
| | | | added | | |
| 44 | C-44 | A-5 | Not | 16 | 10 |
| | | | added | | |
| 45 | C-45 | A-5 | Not | 16 | 10 |
| | | | added | | |
| 46 | C-46 | A-5 | Not | 16 | 10 |
| | | | added | | |
| 47 | C-47 | A-5 | Not | 16 | 10 |
| | | | added | | |
| 48 | C-48 | A-5 | Not | 16 | 10 |
| | | | added | | |
| 49 | C-49 | A-5 | Not | 16 | 10 |
| | | | added | | |
| 50 | C-50 | A-5 | Not | 16 | 10 |
| | | | added | | |
| 51 | C-51 | A-5 | Not | 16 | 10 |
| | | | added | | |
| 52 | C-52 | A-5 | Not | 21 | 20 |
| | | | added | | |
| 53 | C-53 | A-5 | Not | 20 | 19 |
| | | | added | | |
| 54 | C-54 | A-5 | Not | 20 | 19 |
| | | | added | | |
| 55 | C-55 | A-5 | Not | 20 | 20 |
| | | | added | | |

TABLE 13

| | | | | Power | Playback |
|---|---|---|---|---|---|
| | | | | margin | durability |
| Sample No. | Cation | Anion | Quencher | (%) | (×10,000 times) |
| 1 | C-1 | A-4 | Not | 19 | 15 |
| | | | added | | |
| 2 | C-2 | A-4 | Not | 19 | 20 |
| | | | added | | |
| 3 | C-3 | A-4 | Not | 17 | 10 |
| | | | added | | |
| 4 | C-4 | A-4 | Not | 18 | 12 |
| | | | added | | |
| 5 | C-5 | A-4 | Not | 18 | 12 |
| | | | added | | |
| 6 | C-6 | A-4 | Not | 18 | 14 |
| | | | added | | |
| 7 | C-7 | A-4 | Not | 18 | 14 |
| | | | added | | |
| 8 | C-8 | A-4 | Not | 19 | 14 |
| | | | added | | |
| 9 | C-9 | A-4 | Not | 18 | 14 |
| | | | added | | |
| 10 | C-10 | A-4 | Not | 18 | 14 |
| | | | added | | |
| 11 | C-11 | A-4 | Not | 19 | 14 |
| | | | added | | |
| 12 | C-12 | A-4 | Not | 18 | 14 |
| | | | added | | |
| 13 | C-13 | A-4 | Not | 18 | 14 |
| | | | added | | |
| 14 | C-14 | A-4 | Not | 16 | 14 |
| | | | added | | |
| 15 | C-15 | A-4 | Not | 16 | 14 |
| | | | added | | |
| 16 | C-16 | A-4 | Not | 16 | 14 |
| | | | added | | |
| 17 | C-17 | A-4 | Not | 17 | 14 |
| | | | added | | |
| 18 | C-18 | A-4 | Not | 16 | 14 |
| | | | added | | |
| 19 | C-19 | A-4 | Not | 17 | 14 |
| | | | added | | |
| 20 | C-20 | A-4 | Not | 17 | 14 |
| | | | added | | |
| 21 | C-21 | A-4 | Not | 17 | 14 |
| | | | added | | |
| 22 | C-22 | A-4 | Not | 18 | 14 |
| | | | added | | |
| 23 | C-23 | A-4 | Not | 18 | 14 |
| | | | added | | |
| 24 | C-24 | A-4 | Not | 18 | 19 |
| | | | added | | |
| 25 | C-25 | A-4 | Not | 17 | 18 |
| | | | added | | |
| 26 | C-26 | A-4 | Not | 17 | 20 |
| | | | added | | |
| 27 | C-27 | A-4 | Not | 17 | 20 |
| | | | added | | |
| 28 | C-28 | A-4 | Not | 16 | 20 |
| | | | added | | |
| 29 | C-29 | A-4 | Not | 16 | 20 |
| | | | added | | |
| 30 | C-30 | A-4 | Not | 16 | 20 |
| | | | added | | |
| 31 | C-31 | A-4 | Not | 17 | 20 |
| | | | added | | |
| 32 | C-32 | A-4 | Not | 16 | 20 |
| | | | added | | |
| 33 | C-33 | A-4 | Not | 16 | 20 |
| | | | added | | |
| 34 | C-34 | A-4 | Not | 16 | 20 |
| | | | added | | |
| 35 | C-35 | A-4 | Not | 16 | 20 |
| | | | added | | |
| 36 | C-36 | A-4 | Not | 16 | 20 |
| | | | added | | |
| 37 | C-37 | A-4 | Not | 16 | 20 |
| | | | added | | |
| 38 | C-38 | A-4 | Not | 16 | 20 |
| | | | added | | |
| 39 | C-39 | A-4 | Not | 16 | 20 |
| | | | added | | |
| 40 | C-40 | A-4 | Not | 16 | 20 |
| | | | added | | |
| 41 | C-41 | A-4 | Not | 16 | 20 |
| | | | added | | |
| 42 | C-42 | A-4 | Not | 16 | 20 |
| | | | added | | |
| 43 | C-43 | A-4 | Not | 16 | 20 |
| | | | added | | |
| 44 | C-44 | A-4 | Not | 16 | 20 |
| | | | added | | |
| 45 | C-45 | A-4 | Not | 16 | 20 |
| | | | added | | |
| 46 | C-46 | A-4 | Not | 16 | 20 |
| | | | added | | |
| 47 | C-47 | A-4 | Not | 16 | 20 |
| | | | added | | |
| 48 | C-48 | A-4 | Not | 16 | 20 |
| | | | added | | |
| 49 | C-49 | A-4 | Not | 16 | 20 |
| | | | added | | |
| 50 | C-50 | A-4 | Not | 16 | 20 |
| | | | added | | |
| 51 | C-51 | A-4 | Not | 16 | 20 |
| | | | added | | |
| 52 | C-52 | A-4 | Not | 20 | 22 |
| | | | added | | |
| 53 | C-53 | A-4 | Not | 21 | 23 |
| | | | added | | |
| 54 | C-54 | A-4 | Not | 21 | 25 |
| | | | added | | |
| 55 | C-55 | A-4 | Not | 22 | 23 |
| | | | added | | |

TABLE 14

| | | | | Power | Playback |
|---|---|---|---|---|---|
| | | | | margin | durability |
| Sample No. | Cation | Anion | Quencher | (%) | (×10,000 times) |
| 1 | C-1 | A-3 | Not | 19 | 30 |
| | | | added | | |
| 2 | C-2 | A-3 | Not | 19 | 30 |
| | | | added | | |
| 3 | C-3 | A-3 | Not | 18 | 20 |
| | | | added | | |
| 4 | C-4 | A-3 | Not | 18 | 20 |
| | | | added | | |
| 5 | C-5 | A-3 | Not | 18 | 20 |
| | | | added | | |
| 6 | C-6 | A-3 | Not | 19 | 20 |
| | | | added | | |
| 7 | C-7 | A-3 | Not | 19 | 20 |
| | | | added | | |
| 8 | C-8 | A-3 | Not | 19 | 20 |
| | | | added | | |
| 9 | C-9 | A-3 | Not | 19 | 20 |
| | | | added | | |
| 10 | C-10 | A-3 | Not | 19 | 20 |
| | | | added | | |
| 11 | C-11 | A-3 | Not | 19 | 20 |
| | | | added | | |
| 12 | C-12 | A-3 | Not | 21 | 10 |
| | | | added | | |
| 13 | C-13 | A-3 | Not | 21 | 10 |
| | | | added | | |
| 14 | C-14 | A-3 | Not | 18 | 10 |
| | | | added | | |
| 15 | C-15 | A-3 | Not | 18 | 10 |
| | | | added | | |
| 16 | C-16 | A-3 | Not | 18 | 10 |
| | | | added | | |
| 17 | C-17 | A-3 | Not | 17 | 10 |
| | | | added | | |
| 18 | C-18 | A-3 | Not | 16 | 10 |
| | | | added | | |
| 19 | C-19 | A-3 | Not | 18 | 10 |
| | | | added | | |
| 20 | C-20 | A-3 | Not | 18 | 10 |
| | | | added | | |
| 21 | C-21 | A-3 | Not | 18 | 10 |
| | | | added | | |
| 22 | C-22 | A-3 | Not | 18 | 10 |
| | | | added | | |
| 23 | C-23 | A-3 | Not | 18 | 10 |
| | | | added | | |
| 24 | C-24 | A-3 | Not | 18 | 10 |
| | | | added | | |
| 25 | C-25 | A-3 | Not | 18 | 10 |
| | | | added | | |
| 26 | C-26 | A-3 | Not | 19 | 10 |
| | | | added | | |
| 27 | C-27 | A-3 | Not | 19 | 25 |
| | | | added | | |
| 28 | C-28 | A-3 | Not | 16 | 25 |
| | | | added | | |
| 29 | C-29 | A-3 | Not | 16 | 25 |
| | | | added | | |
| 30 | C-30 | A-3 | Not | 16 | 25 |
| | | | added | | |
| 31 | C-31 | A-3 | Not | 17 | 25 |
| | | | added | | |
| 32 | C-32 | A-3 | Not | 18 | 25 |
| | | | added | | |
| 33 | C-33 | A-3 | Not | 18 | 25 |
| | | | added | | |
| 34 | C-34 | A-3 | Not | 18 | 25 |
| | | | added | | |
| 35 | C-35 | A-3 | Not | 18 | 25 |
| | | | added | | |
| 36 | C-36 | A-3 | Not | 18 | 25 |
| | | | added | | |
| 37 | C-37 | A-3 | Not | 18 | 25 |
| | | | added | | |
| 38 | C-38 | A-3 | Not | 18 | 25 |
| | | | added | | |
| 39 | C-39 | A-3 | Not | 18 | 25 |
| | | | added | | |
| 40 | C-40 | A-3 | Not | 18 | 25 |
| | | | added | | |
| 41 | C-41 | A-3 | Not | 18 | 20 |
| | | | added | | |
| 42 | C-42 | A-3 | Not | 18 | 20 |
| | | | added | | |
| 43 | C-43 | A-3 | Not | 18 | 20 |
| | | | added | | |
| 44 | C-44 | A-3 | Not | 18 | 20 |
| | | | added | | |
| 45 | C-45 | A-3 | Not | 18 | 20 |
| | | | added | | |
| 46 | C-46 | A-3 | Not | 18 | 20 |
| | | | added | | |
| 47 | C-47 | A-3 | Not | 18 | 20 |
| | | | added | | |
| 48 | C-48 | A-3 | Not | 18 | 20 |
| | | | added | | |
| 49 | C-49 | A-3 | Not | 18 | 15 |
| | | | added | | |
| 50 | C-50 | A-3 | Not | 18 | 15 |
| | | | added | | |
| 51 | C-51 | A-3 | Not | 18 | 15 |
| | | | added | | |
| 52 | C-52 | A-3 | Not | 26 | 25 |
| | | | added | | |
| 53 | C-53 | A-3 | Not | 22 | 25 |
| | | | added | | |
| 54 | C-54 | A-3 | Not | 22 | 25 |
| | | | added | | |
| 55 | C-55 | A-3 | Not | 20 | 25 |
| | | | added | | |

TABLE 15

| | | | | Power | Playback |
|---|---|---|---|---|---|
| | | | | margin | durability |
| Sample No. | Cation | Anion | Quencher | (%) | (×10,000 times) |
| 1 | C-1 | A-2 | Not | 18 | 40 |
| | | | added | | |
| 2 | C-2 | A-2 | Not | 18 | 40 |
| | | | added | | |
| 3 | C-3 | A-2 | Not | 17 | 30 |
| | | | added | | |
| 4 | C-4 | A-2 | Not | 19 | 25 |
| | | | added | | |
| 5 | C-5 | A-2 | Not | 19 | 20 |
| | | | added | | |
| 6 | C-6 | A-2 | Not | 18 | 20 |
| | | | added | | |
| 7 | C-7 | A-2 | Not | 19 | 20 |
| | | | added | | |
| 8 | C-8 | A-2 | Not | 19 | 20 |
| | | | added | | |
| 9 | C-9 | A-2 | Not | 20 | 20 |
| | | | added | | |
| 10 | C-10 | A-2 | Not | 20 | 20 |
| | | | added | | |
| 11 | C-11 | A-2 | Not | 19 | 20 |
| | | | added | | |
| 12 | C-12 | A-2 | Not | 18 | 20 |
| | | | added | | |
| 13 | C-13 | A-2 | Not | 18 | 20 |
| | | | added | | |
| 14 | C-14 | A-2 | Not | 17 | 20 |
| | | | added | | |
| 15 | C-15 | A-2 | Not | 17 | 20 |
| | | | added | | |
| 16 | C-16 | A-2 | Not | 16 | 20 |
| | | | added | | |
| 17 | C-17 | A-2 | Not | 17 | 20 |
| | | | added | | |
| 18 | C-18 | A-2 | Not | 16 | 20 |
| | | | added | | |
| 19 | C-19 | A-2 | Not | 17 | 20 |
| | | | added | | |
| 20 | C-20 | A-2 | Not | 17 | 20 |
| | | | added | | |
| 21 | C-21 | A-2 | Not | 17 | 20 |
| | | | added | | |
| 22 | C-22 | A-2 | Not | 18 | 15 |
| | | | added | | |
| 23 | C-23 | A-2 | Not | 19 | 15 |
| | | | added | | |
| 24 | C-24 | A-2 | Not | 19 | 15 |
| | | | added | | |
| 25 | C-25 | A-2 | Not | 19 | 15 |
| | | | added | | |
| 26 | C-26 | A-2 | Not | 19 | 15 |
| | | | added | | |
| 27 | C-27 | A-2 | Not | 19 | 15 |
| | | | added | | |
| 28 | C-28 | A-2 | Not | 16 | 15 |
| | | | added | | |
| 29 | C-29 | A-2 | Not | 16 | 15 |
| | | | added | | |
| 30 | C-30 | A-2 | Not | 16 | 15 |
| | | | added | | |
| 31 | C-31 | A-2 | Not | 17 | 15 |
| | | | added | | |
| 32 | C-32 | A-2 | Not | 16 | 15 |
| | | | added | | |
| 33 | C-33 | A-2 | Not | 16 | 15 |
| | | | added | | |
| 34 | C-34 | A-2 | Not | 16 | 15 |
| | | | added | | |
| 35 | C-35 | A-2 | Not | 16 | 15 |
| | | | added | | |
| 36 | C-36 | A-2 | Not | 16 | 15 |
| | | | added | | |
| 37 | C-37 | A-2 | Not | 16 | 15 |
| | | | added | | |
| 38 | C-38 | A-2 | Not | 16 | 15 |
| | | | added | | |
| 39 | C-39 | A-2 | Not | 16 | 15 |
| | | | added | | |
| 40 | C-40 | A-2 | Not | 16 | 15 |
| | | | added | | |
| 41 | C-41 | A-2 | Not | 16 | 15 |
| | | | added | | |
| 42 | C-42 | A-2 | Not | 16 | 15 |
| | | | added | | |
| 43 | C-43 | A-2 | Not | 16 | 15 |
| | | | added | | |
| 44 | C-44 | A-2 | Not | 16 | 15 |
| | | | added | | |
| 45 | C-45 | A-2 | Not | 16 | 15 |
| | | | added | | |
| 46 | C-46 | A-2 | Not | 16 | 15 |
| | | | added | | |
| 47 | C-47 | A-2 | Not | 16 | 15 |
| | | | added | | |
| 48 | C-48 | A-2 | Not | 16 | 15 |
| | | | added | | |
| 49 | C-49 | A-2 | Not | 16 | 15 |
| | | | added | | |
| 50 | C-50 | A-2 | Not | 16 | 15 |
| | | | added | | |
| 51 | C-51 | A-2 | Not | 16 | 15 |
| | | | added | | |
| 52 | C-52 | A-2 | Not | 25 | 30 |
| | | | added | | |
| 53 | C-53 | A-2 | Not | 23 | 25 |
| | | | added | | |
| 54 | C-54 | A-2 | Not | 24 | 20 |
| | | | added | | |
| 55 | C-55 | A-2 | Not | 26 | 25 |
| | | | added | | |

TABLE 16

| | | | | Power | Playback |
|---|---|---|---|---|---|
| | | | | margin | durability |
| Sample No. | Cation | Anion | Quencher | (%) | (×10,000 times) |
| 1 | C-1 | A-1 | Not | 18 | 50 |
| | | | added | | |
| 2 | C-2 | A-1 | Not | 18 | 45 |
| | | | added | | |
| 3 | C-3 | A-1 | Not | 17 | 30 |
| | | | added | | |
| 4 | C-4 | A-1 | Not | 19 | 40 |
| | | | added | | |
| 5 | C-5 | A-1 | Not | 19 | 40 |
| | | | added | | |
| 6 | C-6 | A-1 | Not | 18 | 30 |
| | | | added | | |
| 7 | C-7 | A-1 | Not | 19 | 30 |
| | | | added | | |
| 8 | C-8 | A-1 | Not | 19 | 30 |
| | | | added | | |
| 9 | C-9 | A-1 | Not | 20 | 30 |
| | | | added | | |
| 10 | C-10 | A-1 | Not | 20 | 30 |
| | | | added | | |
| 11 | C-11 | A-1 | Not | 19 | 30 |
| | | | added | | |
| 12 | C-12 | A-1 | Not | 18 | 30 |
| | | | added | | |
| 13 | C-13 | A-1 | Not | 18 | 30 |
| | | | added | | |
| 14 | C-14 | A-1 | Not | 17 | 30 |
| | | | added | | |
| 15 | C-15 | A-1 | Not | 17 | 30 |
| | | | added | | |
| 16 | C-16 | A-1 | Not | 16 | 30 |
| | | | added | | |
| 17 | C-17 | A-1 | Not | 17 | 30 |
| | | | added | | |
| 18 | C-18 | A-1 | Not | 16 | 30 |
| | | | added | | |
| 19 | C-19 | A-1 | Not | 17 | 30 |
| | | | added | | |
| 20 | C-20 | A-1 | Not | 17 | 30 |
| | | | added | | |
| 21 | C-21 | A-1 | Not | 17 | 30 |
| | | | added | | |
| 22 | C-22 | A-1 | Not | 18 | 30 |
| | | | added | | |
| 23 | C-23 | A-1 | Not | 19 | 30 |
| | | | added | | |
| 24 | C-24 | A-1 | Not | 19 | 30 |
| | | | added | | |
| 25 | C-25 | A-1 | Not | 19 | 30 |
| | | | added | | |
| 26 | C-26 | A-1 | Not | 19 | 30 |
| | | | added | | |
| 27 | C-27 | A-1 | Not | 19 | 30 |
| | | | added | | |
| 28 | C-28 | A-1 | Not | 16 | 30 |
| | | | added | | |
| 29 | C-29 | A-1 | Not | 16 | 25 |
| | | | added | | |
| 30 | C-30 | A-1 | Not | 16 | 25 |
| | | | added | | |
| 31 | C-31 | A-1 | Not | 17 | 25 |
| | | | added | | |
| 32 | C-32 | A-1 | Not | 16 | 25 |
| | | | added | | |
| 33 | C-33 | A-1 | Not | 16 | 25 |
| | | | added | | |
| 34 | C-34 | A-1 | Not | 16 | 25 |
| | | | added | | |
| 35 | C-35 | A-1 | Not | 16 | 25 |
| | | | added | | |
| 36 | C-36 | A-1 | Not | 16 | 25 |
| | | | added | | |
| 37 | C-37 | A-1 | Not | 16 | 25 |
| | | | added | | |
| 38 | C-38 | A-1 | Not | 16 | 25 |
| | | | added | | |
| 39 | C-39 | A-1 | Not | 16 | 25 |
| | | | added | | |
| 40 | C-40 | A-1 | Not | 16 | 25 |
| | | | added | | |
| 41 | C-41 | A-1 | Not | 16 | 25 |
| | | | added | | |
| 42 | C-42 | A-1 | Not | 16 | 25 |
| | | | added | | |
| 43 | C-43 | A-1 | Not | 16 | 25 |
| | | | added | | |
| 44 | C-44 | A-1 | Not | 16 | 25 |
| | | | added | | |
| 45 | C-45 | A-1 | Not | 16 | 25 |
| | | | added | | |
| 46 | C-46 | A-1 | Not | 16 | 25 |
| | | | added | | |
| 47 | C-47 | A-1 | Not | 16 | 25 |
| | | | added | | |
| 48 | C-48 | A-1 | Not | 16 | 25 |
| | | | added | | |
| 49 | C-49 | A-1 | Not | 16 | 25 |
| | | | added | | |
| 50 | C-50 | A-1 | Not | 16 | 25 |
| | | | added | | |
| 51 | C-51 | A-1 | Not | 16 | 25 |
| | | | added | | |
| 52 | C-52 | A-1 | Not | 25 | 30 |
| | | | added | | |
| 53 | C-53 | A-1 | Not | 23 | 30 |
| | | | added | | |
| 54 | C-54 | A-1 | Not | 24 | 30 |
| | | | added | | |
| 55 | C-55 | A-1 | Not | 26 | 30 |
| | | | added | | |

TABLE 17

| | | | | Power | Playback |
|---|---|---|---|---|---|
| | | | Quencher | margin | durability |
| Sample No. | Cation | Anion | (%) | (%) | (×10,000 times) |
| 1 | C-52 | A-1 | 2 | 10 | 50 |
| 2 | C-52 | A-1 | 3 | 26 | 45 |
| 3 | C-52 | A-1 | 5 | 25 | 30 |
| 4 | C-52 | A-1 | 10 | 25 | 40 |
| 5 | C-52 | A-1 | 11 | 10 | 40 |
| 6 | C-53 | A-1 | 2 | 9 | 30 |
| 7 | C-53 | A-1 | 3 | 27 | 30 |
| 8 | C-53 | A-1 | 5 | 23 | 30 |
| 9 | C-53 | A-1 | 10 | 23 | 30 |
| 10 | C-53 | A-1 | 11 | 8 | 30 |
| 11 | C-54 | A-1 | 2 | 8 | 30 |
| 12 | C-54 | A-1 | 3 | 26 | 30 |
| 13 | C-54 | A-1 | 5 | 24 | 30 |
| 14 | C-54 | A-1 | 10 | 24 | 30 |
| 15 | C-54 | A-1 | 11 | 7 | 30 |
| 16 | C-55 | A-1 | 2 | 9 | 30 |
| 17 | C-55 | A-1 | 3 | 2 | 30 |
| 18 | C-55 | A-1 | 5 | 26 | 30 |
| 19 | C-55 | A-1 | 10 | 26 | 30 |
| 20 | C-55 | A-1 | 11 | 10 | 30 |
| 21 | C-52 | A-8 | 2 | 10 | 25 |
| 22 | C-52 | A-8 | 3 | 27 | 25 |
| 23 | C-52 | A-8 | 5 | 26 | 25 |
| 24 | C-52 | A-8 | 10 | 26 | 25 |
| 25 | C-52 | A-8 | 11 | 11 | 25 |
| 26 | C-53 | A-8 | 2 | 9 | 25 |
| 27 | C-53 | A-8 | 3 | 27 | 25 |
| 28 | C-53 | A-8 | 5 | 25 | 25 |
| 29 | C-53 | A-8 | 10 | 25 | 25 |
| 30 | C-53 | A-8 | 11 | 10 | 25 |
| 31 | C-54 | A-8 | 2 | 8 | 25 |
| 32 | C-54 | A-8 | 3 | 26 | 25 |
| 33 | C-54 | A-8 | 5 | 25 | 25 |
| 34 | C-54 | A-8 | 10 | 25 | 25 |
| 35 | C-54 | A-8 | 11 | 9 | 25 |
| 36 | C-54 | A-8 | 2 | 10 | 25 |
| 37 | C-54 | A-8 | 3 | 27 | 25 |
| 38 | C-54 | A-8 | 5 | 25 | 25 |
| 39 | C-54 | A-8 | 10 | 25 | 25 |
| 40 | C-54 | A-8 | 11 | 10 | 25 |
| 41 | C-55 | A-8 | 2 | 9 | 25 |
| 42 | C-55 | A-8 | 3 | 26 | 25 |
| 43 | C-55 | A-8 | 5 | 24 | 25 |
| 44 | C-55 | A-8 | 10 | 24 | 25 |
| 45 | C-55 | A-8 | 11 | 10 | 25 |

The above results demonstrate that the reproducing light durability count was obviously better, i.e., 1,000,000 or more when the quencher of the present invention was added. The recording power margin was also 15% or more.

From the foregoing, the use of the present invention makes high-quality information recording and reproduction possible even at a high linear velocity.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recordable information recording medium comprising:
a substrate comprising either concentric or spiral grooves and lands; and
a recording layer comprising a reflecting layer on the grooves and lands of the substrate;
an organic dye layer on the reflecting layer; and
a recording mark, the light reflectance of the recording mark being higher than the light reflectance of the organic dye layer without the recording mark,
wherein the organic dye layer comprises an organic dye comprising a cation portion comprising monomethinecyanine and an anion portion comprising an azo metal complex, and a quencher comprising a formazan metal complex, and
the grooves are configured to wobble within a predetermined amplitude range.

2. The medium of claim 1, wherein the formazan metal complex is represented by formula H-1: 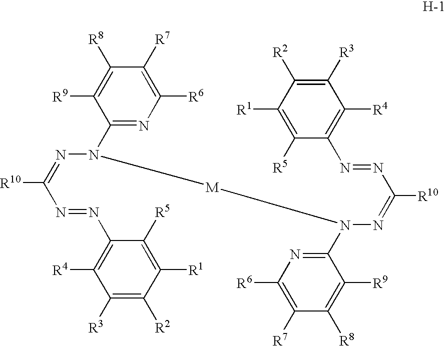
wherein R¹, R², R³, R⁴, R⁵, R⁶, R⁷, R⁸ and R⁹ are independently an optionally substituted aliphatic hydrocarbon having from 1 to 5 carbon atoms, an optionally substituted ether group having from 1 to 7 carbon atoms, an optionally substituted amino group having from 1 to 8 carbon atoms; a halogen group; a nitro group, or a cyano group;
each R¹⁰ is independently an optionally substituted pyridine ring, an optionally substituted furan ring, or an optionally substituted aliphatic hydrocarbon group having from 1 to 5 carbon atoms; and
M is scandium, yttrium, titanium, zirconium, hafnium, vanadium, niobium, tantalum, chrome, molybdenum, tungsten, manganese, technetium, rhenium, iron, cobalt, nickel, rubidium, rhodium, palladium, osmium, iridium, platinum, copper, gold, zinc, cadmium, mercury, an oxide thereof, or a halide thereof.

3. The medium of claim 2, wherein the formazan metal complex is further represented the formula:

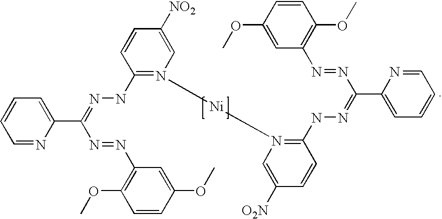

4. The medium of claim 2, wherein the formazan metal complex is further represented the formula:

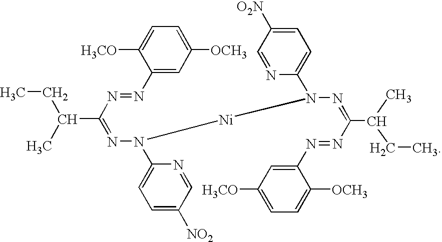

5. The medium of claim 2, wherein the formazan metal complex is further represented the formula:

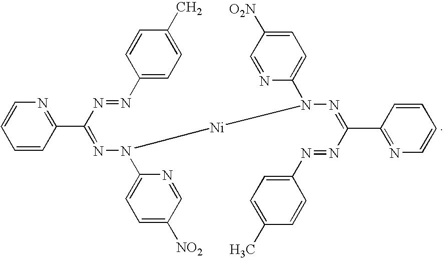

6. The medium of claim 2, wherein the formazan metal complex is further represented the formula:

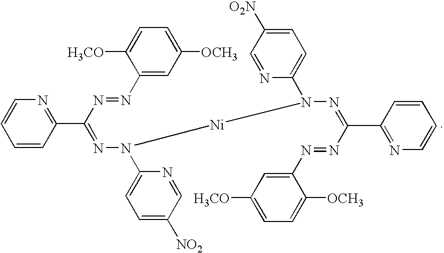

7. The medium of claim 2, wherein the formazan metal complex is further represented the formula: [chemical structure]
